(19) United States
(12) Patent Application Publication
(10) Pub. No.: US 2005/0177435 A1
(43) Pub. Date: Aug. 11, 2005

(54) Supply chain network

(76) Inventor: Derek Lidow, Santa Monica, CA (US)

Correspondence Address: OSTROLENK FABER GERB & SOFFEN, 1180 AVENUE OF THE AMERICAS, NEW YORK, NY, 100368403, US

(21) Appl. No.: 10/497,055

(22) PCT Filed: Nov. 27, 2002
(86) PCT No.: PCT/US02/38438

Related U.S. Application Data
(60) Provisional application No. 60/333,483, filed on Nov. 28, 2001.

(51) Int. Cl. G06F 17/60

(52) U.S. Cl. 705/22

(57) ABSTRACT

A supply chain network (70) in which customers (72), suppliers (76), logistics providers (78), carriers, and financial institutions are all connected to a centralized supply chain server (74). The supply chain server (74) is central to a many-to-many relationship. Accordingly, the server (74) handles various management activities for each member of the supply chain, such as negotiating prices, terms and conditions, managing supply and demand, and maintaining transaction information. In the process, the supply chain server, (74) gathers significant amounts of relevant data and becomes a central repository for such information. Consequently, the supply chain server (74) is in a unique position to utilize the data for the benefit of the members of the supply chain and others.

### CROSS-REFERENCE TO RELATED APPLICATIONS

This application is based upon and claims priority to U.S. provisional patent application Ser. No. 60/333,483, filed Nov. 28, 2001, entitled SUPPLY CHAIN NETWORK, the entirety of which is incorporated herein by reference.

### FIELD OF THE INVENTION

The present invention relates to a supply chain network of suppliers and customers and, more particularly, to planning, order management, logistics, and billing and payment processes as implemented through a supply chain server in the supply chain network.

### DESCRIPTION OF THE RELATED ART

Manufacturers require components, materials, and services to produce their goods. Components, materials, and services often are provided by various suppliers. Supply chains deliver components, materials, and services (generally referred to as “components”) from the suppliers to the manufacturers and service providers (also referred to as “customers.”) Manufacturers and suppliers continuously are interested in reducing costs. Supply chain management makes up a substantial portion of their costs.

In general, a supply chain involves any and all activities associated with defining, designing, producing, receiving, monitoring, storing, and using the components and sub-components used in manufacturing a product or providing a service. Manufacturers often find themselves paying higher prices, being short of product components in times of high demand, forecasting needs inaccurately, and creating slow moving inventories because they lack the expertise and resources to manage their supply chain properly.

Moreover, supply chain costs constitute a significant fraction of a manufacturer's total expenditures. For example, supply chain costs include: planning, purchasing, inbound freight, receiving, inventory management and carrying costs, supplier monitoring, measurement, management, and the payment of invoices. These costs can account for between 5% and 25% of corporate expenditures. A 20% reduction in supply chain costs would significantly improve, and in many cases could double, the profits of a given manufacturer.

A typical prior art supply chain 50 is shown in FIG. 1. Customers generally have two methods for procuring components using prior art supply chains, depending generally on the customer's size. Original equipment manufacturers (“OEMs”), contract electronics manufacturers (“CEMs”—not shown), and other large customers 52 typically buy directly from a component supplier 56. This technique is known in the industry as “buying direct.” Large customer 52 places an order with supplier 56 each time parts are needed. Supplier 56 gives the products to a carrier 58 who, in turn, delivers the ordered parts to large customer 52.

On the other hand, small customers 54 typically make purchases through a third party distributor or agent 60. Distributor 60 purchases parts from supplier 56. A carrier 62 brings the products to distributor 60. Distributor 60 transfers the products to another carrier 64 who delivers the products to small customers 54.

Other types of third party distributors use an electronic means to hold auctions for components. However, as the time involved in attending the electronic auction is lengthy, such services are rarely used except for one-time, or spot component requirements.

Known supply chain networks commonly yield missed shipments and discontinuity of component supply to customers. These deficiencies particularly frustrate customers in times of “allocation” where there are shortages of key components. Shortages and discontinuities cause delays in end product shipments, with corresponding loss of revenues and profits for manufacturers.

Component suppliers 56 in particular are frustrated with prior art supply chains. Changes in market conditions for the various end products yield very volatile manufacturing schedules, resulting in inefficient factory usage and higher costs. Component suppliers 56 also have invested heavily in Materials Resource Planning (MRP) and Enterprise Resource Planning (ERP) systems in efforts to incrementally improve factory loading and inventory levels. Accordingly, component suppliers attempt to provide parts based upon production plans generated by a customer factory or series of factories. These efforts often produce disappointing results because they operate only with respect to each individual component supplier and often only process production plans on a weekly basis. As such, the systems typically react slowly when compared with the rate of order fluctuations and are unable to detect excess inventories located in non-primary warehouses, thereby resulting in excess parts being ordered.

To solve some of these problems, some larger manufacturing customers 52 require that suppliers 56 maintain dedicated on-site or local consignment inventories of required products. Of course, maintaining these additional inventory locations is very costly and difficult to control. The additional inventories also create further inefficiencies in use of production capacity and total inventory.

Additionally, distributors 60 who supply small customers 54 often require 7% to 35% gross margin points to manage and cover inventory handling costs, in addition to the supply chain costs already borne by these customers 54. These distributor margins reduce supplier 56 profitability on small and medium sized customers 54, and produce a tension between suppliers 56 and distributors 60 on how or whether to limit distributor margins. Furthermore, distribution orders cost more to administer with special processes and systems required to manage “ship-and-debit” pricing and stock rotations. Finally, selling and servicing customers costs between 5% and 10% of sales—excluding marketing and advertising costs. Suppliers 56 have difficulty finding a pay-back for these investments.

Significantly, there are payment problems in prior art supply chains as well. In many prior art systems, products are sold to customers 52, 54 with payment terms that are skirted or ignored. For example, the customers receive components from suppliers 56 and then have 30 days from delivery to provide payment. Customers frequently take advantage of this payment term and do not pay until after the term has expired, for example, 45 days from delivery. Customers find this arrangement more desirable than taking a loan to cover the costs of the products and paying the loan on time. By delaying payment, customer balance sheets indicate a payable instead of a loan, a more attractive view for investors. It generally is not worthwhile for suppliers 56 to complain about a 15 day discrepancy, but the suppliers lose money during those 15 days. To solve this problem, suppliers 56 create a defacto interest, for money expected to be lost due to late payment, by charging customers more for parts. This de facto interest is clearly undesirable for customers 52, 54.

Moreover, toward the end of accounting periods, suppliers 56 frequently ship products ahead of schedule to improve their balance sheets. Distributors 60 for the suppliers 56 are aware of this and consequently require suppliers to discount goods received before scheduled shipments. These extra discounts represent yet another disadvantage of known supply chain networks.

Thus, there exists a need in the art for a supply chain architecture which can remove the inefficiencies described above and thereby reduce losses incurred by both customers and suppliers in the sale and distribution of products.

### SUMMARY OF THE INVENTION

The present invention overcomes the disadvantages of the prior art by providing a supply chain network having planning, order management, logistics, and payment processes which accommodate the various requirements of customers (manufacturers) and suppliers (producers) in the supply chain.

Overview

The present invention provides a supply chain of suppliers networked to manufacturers through a supply chain server in a many-to-many relationship. The supply chain network includes, along with the manufacturers and suppliers, logistics providers, carriers, and financial institutions, all connected through the centralized supply chain server. The supply chain server executes planning, order management, logistics, and payment functions for the network. Exception processing is undertaken as necessary. Network management services undertaken by the supply chain server include supply base management, operations management, and infrastructure management.

Planning is executed tactically based on forecasts received from customers. The supply chain server matches supply and demand, and resolves shortages to optimize the many-to-many supply network. Order management is based on product types and liability terms, governed by underlying contractual agreements. Supplier schedules and customer delivery commitments are converted into shippable orders. Logistics involve picking up product at a supplier's dock and moving the product through a “touch-and-go” cross-dock network. Aggregate supplier orders are broken down into customer shipments and delivered to each customer's dock. Payments are accepted by the supply chain server in aggregate and passed through to the appropriate suppliers. No product mark up or cash float is involved.

Planning

As part of the planning process, the supply chain server receives forecasts from the customers detailing the orders that the customers desire. These forecasts are analyzed by the supply chain server to ensure that they conform to contractual agreements and do not contain errors. The forecasts are also used to warn the suppliers of future demands so that the suppliers can anticipate demands and plan inventory accordingly.

The supply chain server checks with the suppliers to determine whether the forecasts can be fulfilled by the suppliers. If the forecasts cannot be fulfilled by the suppliers, the supply chain server contacts customers and suppliers and attempts to either redistribute customer demands to different suppliers or requests that customers alter their demands. When supply issues have been resolved, customer orders are sent to the suppliers in bundled groups. Consequently, suppliers are able to prepare a smaller number of larger orders, which enhances economy of scale.

Exception processing handled by the supply chain server in execution of the planning functions includes allocation, performing “what-if” scenarios, and shortage chasing.

Order Management

As part of the order management process, the supply chain server oversees and controls the processes involved in distributing the product from the suppliers to the customers including the generation of purchase orders and invoices. If a customer wishes to return a product, exception processing under order management provides a return process that also is overseen and controlled by the supply chain server. Other exception processing under order management handled by the supply chain server includes unplanned orders and shortages, past due order management, sample orders and data sheets.

Logistics

Logistics involves the fulfillment of orders, including picking up consolidated supplier purchase orders, and breaking bulk shipments by way of cross-dock operations. The smaller shipments then are delivered to each customer's dock. Optionally, advance shipment notices are handled. Exceptions might include direct shipments.

Payment

Payment processes include sending customer invoices, arranging customer financing, receiving customer payments, and paying suppliers. Consolidated payments are made by customers to the supply chain server. Those payments then are forwarded to the appropriate suppliers and logistics providers.

Aggregate customer payments are accepted by the supply network provider and passed through to the appropriate suppliers. There is no product mark up and no float of any cash. Preferably, payment financing is handled through a third party financial services provider.

According to a preferred embodiment, all payments will be made by electronic finds transfer (EFT), but a manual process for paper checks and credit card transactions is available for exceptions and supply network information offerings (such as conferences, white papers, etc.)

In general, suppliers will be paid upon receipt of payment from customers. Advantageously, however, suppliers can be paid even if the supply network provider has not received payment from the customers. This can involve the potential of a financing and/or capital offering and loan servicing. Nevertheless, payments to third party logistics (3PL) providers are made upon receipt of their invoice.

Network Management Services

The supply chain server is uniquely situated to supply base management, operations management, and infrastructure management for the various members of the network. Advantageously, because customers, suppliers, and logistics providers all communicate with the supply chain server, the novel architecture yields useful information not available in the prior art. This information includes, for example, customer demand propensities, supplier performance, etc.

Other features and advantages of the present invention will become apparent from the following description of the invention which refers to the accompanying drawings.

### BRIEF DESCRIPTION OF THE DRAWINGS

FIG. 1 is a block diagram of a prior art supply chain architecture.

FIG. 2 is a block diagram of a supply chain network in accordance with the invention.

FIG. 3 is a block diagram illustrating the modules effectuating the supply chain network of FIG. 2.

FIG. 4 is a diagram illustrating a Demand Capture and Validation process performed by an Planning Module during a regular demand request in accordance with the invention.

FIG. 5 is a diagram illustrating a Demand Capture and Validation process performed by the Planning Module during an ad hoc demand request.

FIG. 6 is a diagram illustrating the processes performed by the Planning Module in accordance with the invention.

FIG. 7 is a diagram illustrating an example of the flow of information during the Planning Module of FIG. 6.

FIG. 8 is a diagram illustrating the processes performed during the Planning Module of FIG. 6 when customer demand exceeds supplier capacity.

FIG. 9 is a diagram illustrating an example of the flow of information during the Planning Module of FIG. 6 upon receipt of an ad hoc customer request.

FIG. 10A is a schematic diagram for the process of creating sales orders.

FIG. 10B is a schematic diagram for the process of maintaining sales orders.

FIG. 10C is a schematic diagram of a process flow detailing the types of change order requests that are handled.

FIG. 10D is a schematic for supply/demand that can be evaluated for orders that exist outside a frozen window.

FIG. 10E is a schematic diagram showing interaction between Planning, Order Management, and Logistics processes performed in the present invention.

FIG. 11A is a diagram illustrating the processes of the Logistics Module in accordance with the invention.

FIG. 11B is a diagram illustrating an error routine performed in the Logistics Module of FIG. 11A.

FIG. 12 is a diagram showing a continuation of the processes performed in the Logistics Module of FIGS. 11A and 11B.

FIG. 13 is a diagram showing a continuation of the processes performed in the Logistics Module of FIGS. 11A and 12.

FIG. 14 is a diagram illustrating the processes performed by the Logistics Module when a customer desires to return an item procured through the supply chain network.

FIG. 15 is diagram showing a continuation of the processes depicted in FIG. 14.

FIG. 16 is a diagram illustrating the flow of information and products during a Logistics Module in accordance with the invention.

FIG. 17 is a diagram illustrating the production of invoices performed by a Billing and Payment Module in accordance with the invention.

FIG. 18 is a diagram showing the payment of invoices during the Billing and Payment Module.

FIG. 19A is a diagram illustrating types of information and corresponding time intervals provided by the supply chain network in accordance with the invention.

FIG. 19B is a schematic diagram of pricing, terms, and conditions management according to the present invention.

FIG. 19C is a schematic illustrating a management system for market supply and demand according to the present invention.

FIG. 20 is a diagram illustrating the flow of title and payment for products in accordance with an embodiment of the invention.

FIG. 21 is a diagram illustrating an alternative process of title and payment for products in accordance with another embodiment of the invention.

FIG. 21A diagrams a subprocess for establishing a credit line and paying invoices related to the method of FIG. 21.

FIG. 21B diagrams a subprocess involving commissions related to the method of FIG. 21.

FIG. 21C diagrams a subprocess involving payment advances and interest charges in connection with the method of FIG. 21.

FIG. 21D diagrams a subprocess involving application of customer payments to invoices in connection with the method of FIG. 21.

FIG. 22 is a diagram illustrating an embodiment of the architectural set up for the supply chain architecture in accordance with the invention.

FIG. 23 is a diagram illustrating an embodiment of a supply chain server in accordance with the invention.

FIG. 24 is a more detailed diagram illustrating the supply chain server environment for the supply chain server shown in FIG. 23.

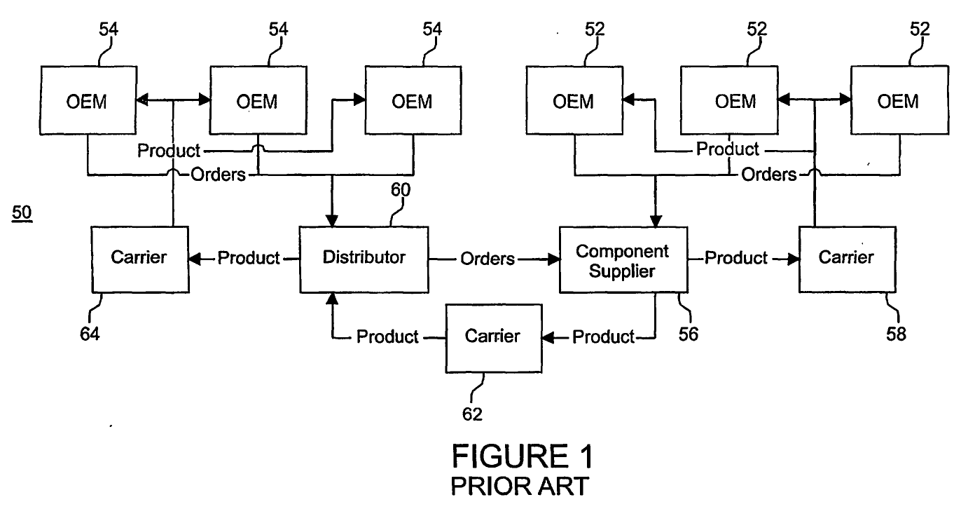

### DETAILED DESCRIPTION OF EMBODIMENTS OF THE INVENTION

General Overview:

In the following description, terms describing processes and hardware are used interchangeably as the functions described could be implemented using many different forms of hardware, software, or even manually.

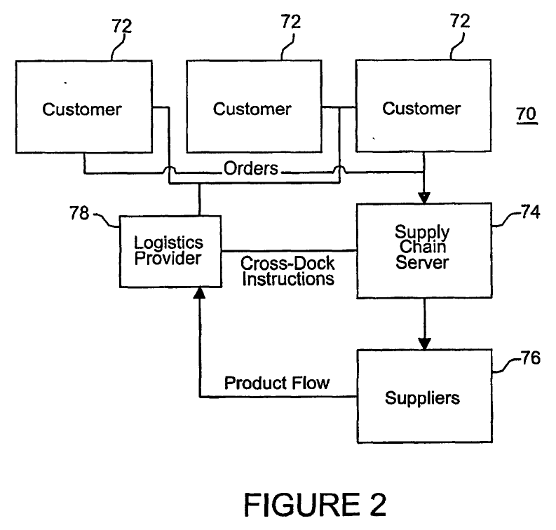

Referring to FIG. 2, a general overview of a many-to-many supply chain network in accordance with the invention is shown.

Supply chain network 70 includes customers 72 of any size. Customers 72 each place forecasts or orders with a supply chain server 74. Although supply chain server 74 typically will include a computer, it will be referred to throughout the description as an entity capable of entering into a contractual relationship. It should be understood that in such descriptions, the operator of the server will be the real party in the contract. It should also be understood that supply chain server 74 need not be implemented as a computer.

Supply chain server 74 accumulates demand forecasts from customers 72 who are using the same or similar products. These demands are then aggregated and supply chain server 74 determines the best method for distributing all the products requested from any approved suppliers 76 to any requesting customers 72. Advantageously, because the customer demands are aggregated by supply chain server 74, suppliers 76 only need to assemble a small number of orders compared with the number that otherwise would be required to serve the entire network of customers.

In one embodiment, orders are fulfilled by having the products picked up by a freight company as designated by a logistics provider 78 (herein “3PL”—third party logistics provider) and taken to a location, which can be the same location as where the shipment was picked up. At this stage, instructions are provided by supply chain server 74 for the distribution of the products. These instructions indicate how the order is to be broken down and re-assembled in the exact quantities required by the specific customers. Breaking down the order is called a cross-dock operation and is performed at a cross-dock point. In another embodiment, the customer or the supplier performs the activities ascribed to logistics provider 78.

Advantageously, deciding later in the distribution process to whom and where products will be shipped yields maximum flexibility and minimizes overall cycle time. The process also eliminates the costly need to manage a customer's order within the supplier's order management system. This is advantageous because order management costs can be quite substantial for suppliers managing large numbers of customers and large numbers of different part types and numbers. Consequently, the present invention provides economic advantages, as the cost of managing one order for one part is generally much higher than disassembling a larger order of many parts into specific quantities.

After the products are disassembled, the orders for each individual customer may be shipped to their final destinations using conventional means and carriers. For large quantities of products coming from many different suppliers and going to many different customer locations, the cross dock preferably is located strategically, so as to minimize the overall shipping and handling costs, for example.

Modules

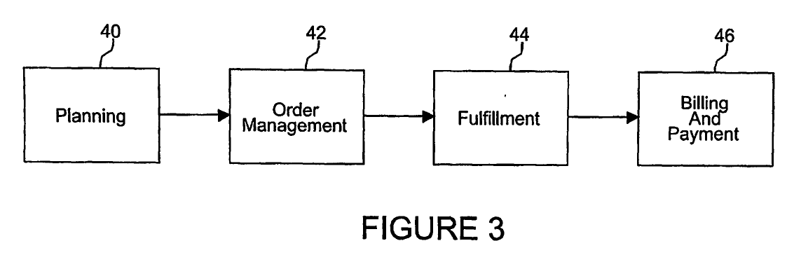

Referring to FIG. 3, the operations of supply chain network 70 can be broken up into four main modules, as follows:
Planning 40—collecting customer forecasts and determining if the requests are valid;
Order Management 42—determining if customer demands exceed supply—and providing solutions if demand does exceed supply;
Logistics 44—transporting the products from suppliers to customers;
Billing and payment 46—generation and payment of invoices.

Although a typical customer demand generally will follow the order of the modules shown in FIG. 3, the Modules operate independently and sometimes concurrently as will be explained more fully below. For example, the Planning for one day's demands may take place at the same time as the Logistics of a previous day's demands. In contrast to prior art supply chain systems, which handled many of these functions as completely independent events, communication takes place between each functional module according to the present invention. For example, logistics in the prior art were handled independently of supplier payments or even order management. According to the present invention, information management is incorporated into each of the modules to the benefit of network users. Information management refers generally to the accumulation of useful supply chain management information that is beneficial to customers and suppliers.

The invention manages all of these activities for many customers and many suppliers simultaneously. This enables the invention to perform these tasks more efficiently for all parties. To illustrate this point, consider a customer X who receives a large rush order requiring certain parts from suppliers A and B, but the suppliers do not have the inventories to meet the customer's needs. By handling many customer and supplier supply and demand requirements simultaneously, a supply chain architecture in accordance with the invention can determine that a supplier C, for example, has extra parts of the same type demanded, and that another customer Y plans to use either supplier B or C for his similar needs. The supply chain server can then arrange for supplier C to ship the parts required by customer Y, thus allowing supplier B to ship the parts required by customer X.

In one embodiment, supply chain network 70 is implemented using a cadence where all transactions are linked to one another and performed on a regular basis. For example, all customers using supply chain network 70 could order all parts, or all parts within a certain commodity family, on a given day of the week. This creates a large economy of scale in the Logistics activities that is passed on to users of the network. Frequently, production requirements are planned over the weekend thereby causing Monday to be a desirable day to start the order cycle. As such, in one embodiment of the invention, Planning takes place on Monday night, Logistics of all parts on Tuesday, and Billing on Tuesday night.

Some parts are used in very high volumes or are perishable. In accordance with the invention, these parts could be planned, ordered, and fulfilled on a daily or hourly cadence. In prior art techniques, many dates had to be entered, tracked, and changed according to the expected delivery status of the product ordered. These are very costly and time consuming tasks as the sequence of information, products, and currency can change depending upon the needs of the specific customers, suppliers and logistics providers that are using the network. The present invention eliminates the need for customers to store large volumes of parts by ensuring continuity of supply.

Product usage by customers is often determined by an ERP computer system on a weekly basis. In contrast, the supply chain network in accordance with the invention realizes order, planning, and delivery times that cumulatively are considerably less than one week. This system enables customers to significantly vary production plans and still be able to receive the necessary parts without using a large quantity and assortment of parts in a costly inventory. This also eliminates the need to manage a multitude of dates in the ERP system.

The individual modules will now be explained in detail with continuing reference to FIG. 3. Note again that portions of these modules will operate concurrently.

Planning

Order Processing:

The Planning Module 40 provides an environment where supply chain server 74 directly interacts with customers 72. This Module includes the processes required to capture customer demand, and obtain the validation and approval required to process that customer demand.

Customers 72 submit their demands for desired products to supply chain server 74 in multiple ways. In a preferred embodiment, customers 72 submit their requests using a thirteen week forecast, week 0 daily call-outs, and ad hoc requests. Accordingly, each week customers 72 submit a thirteen week forecast for each of the Planning/Ship-to locations specified in their contract with supply chain server 74. For high volume and volatile commodities such as DRAMs (dynamic random access memories), customers 72 also communicate their week 0 (i.e., current week) demand by sending daily call-outs. In addition, customers 72 also have the ability to submit any unforecasted demand to supply chain server 74 by sending an ad hoc request. Such an ad hoc request is an order that no supplier has been prepared to receive as it was not forecasted, or was not within forecasting tolerances defined in contractual arrangements between suppliers and customers or defined by contracts for the network. An ad hoc order, therefore, is more likely to be unfulfilled within a standard cadence without intervention from human planners, as discussed below.

Once customer demand is received, it is validated against contract terms and details outlined during an initial customer set-up process. This validation may include verifying that the forecast is complete, ensuring that every part number exists in the supply chain server system, and/or that all required information is complete and accurate. If a customer demand is invalid, abnormal, or incomplete, supply chain server 74 notifies the customer on an exception basis that something is wrong with their request and a resolution process is initiated.

Examples of the analyses that the Planning Module may perform and thereby improve the validity of the forecasts received include, but are not limited to:
identifying major shifts relative to previous weeks' forecasts;
identifying major cumulative shifts in buying patterns; and
identifying requests outside agreed upon capacities.

Supply chain server 74 or Planners can also check supply and demand requirements relative to known customer events such as start-up, end-of-run, and plant shutdowns. Planners are employees of the operator supply chain server 74 who intervene when supply chain server 74 is unable to fulfill all of the unconstrained demand with available supply as is described below. Planners contact customers and suppliers, using email for example, and suggest adjustments to their respective production plans to create a better supply and demand balance for all parties. Server 74 notifies Planners of these conditions using exception reporting. Planners can use a Planner Supply Tool (discussed below) which provides valuable and unique information produced by supply chain server 74. Planners can thus make suggestions on how supply and demand can be balanced that are better than the suggestions that could be performed by a customer or supplier on their own.

In response to an invalid demand, supply chain server 74 sends email or other message alerts, by way of an extranet, for example, to all potentially impacted parties, including the employees of the supply chain server (i.e., Planners). Such message alerts can include, but are not limited to, issuing “Red light” or “Yellow light” alerts to depict relative importance and immediacy of attention required.

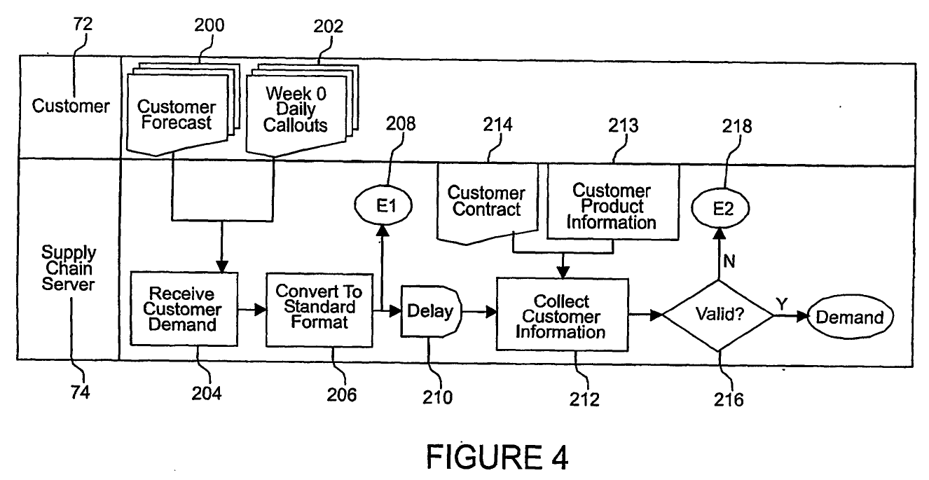

An exemplary embodiment of the Planning Management module 40 will now be explained. Referring to FIG. 4, there is shown a demand capture and validation process performed by the Planning Module during a regular demand schedule. Supply chain server 74 receives 204 thirteen week customer forecasts 200 and week 0 daily call outs 202 from customers 72. The forecasts may be from a single customer, a plurality of customers, or a plurality of sources within a single customer.

Receiving circuit 204 captures the forecasts as customer demands through, for example, an Electronic Data Interchange (EDI) forecast, an email (e.g., with an EXCEL spreadsheet), an EDI purchase order (PO) or through an extensible markup language (XML) communication. Receiving circuit 204 also captures specific services which may not be enumerated in the customer contract. For example, expedited delivery, special labeling, packaging, etc., all may be captured.

Supply chain server 74 converts 206 the customer demands 200, 202 into a standard format used by supply chain server 74 to analyze the customer demands. If there are problems with conversion 206, an error routine 208 is performed to cure all technical difficulties. In a preferred embodiment, all such technical difficulties should be resolved by the end of the business day. A delay circuit 210 ensures that all the converted demands are stored and the required functional validations are performed by the end of the business day. Such a delay allows server 74 to accumulate demands (200, 202) for all customers.

A collect customer information circuit 212 compares the converted customer demands with the corresponding customer contract 214 and with current customer product information 213 regarding customer products. Information 213 includes, for example, approved suppliers, specification revisions levels, etc.

A validation circuit 216 determines whether the converted demands are valid. Validation circuit 216 detects, for example, whether the demanding customer is actually a customer of supply chain network 70. Validation circuit 216 also detects whether customer forecast 200 is complete in that there is one forecast for every planning/ship-to location and part number combination, and that every part number has a specified quantity. Finally, validation circuit 216 may verify that the requested part number relates to a valid part contracted between customer 72 and the entity running supply chain server 74.

If validation circuit 216 determines that a particular customer demand is not valid, an error routine 218 is performed whereby a notification is sent to an Account Manager to resolve the outstanding issues. The Account Manager is used to maintain a current standing for all customers by evaluating their payment history. Supply chain server 74 then sends the customer 72 an exception notification to inform the customer that the demand was incomplete in some way. The exception notification itself is stored in a suspend file until it is acted upon. If the demand is valid, the process proceeds to the next planning phase.

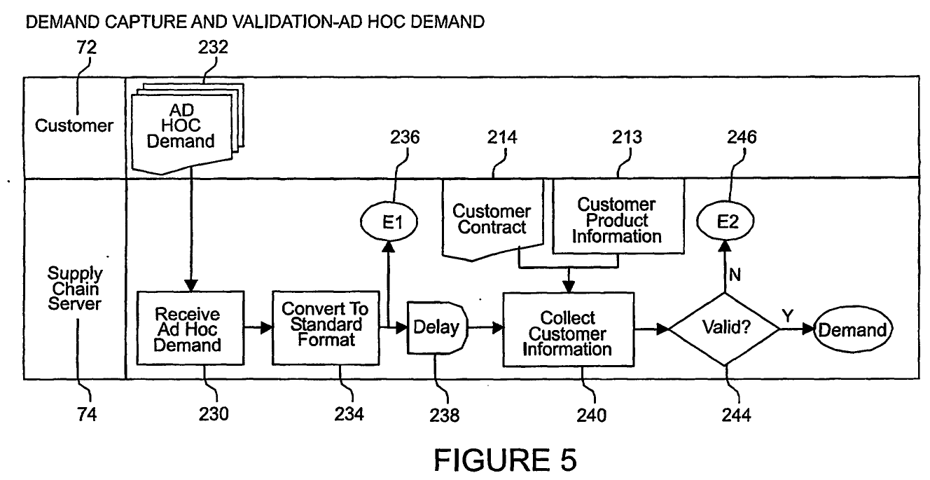

For an ad hoc demand, the process flow of Planning Module 40 is shown in FIG. 5. Referring to FIG. 5, as with a regular customer forecast of FIG. 4, supply chain server 74 receives 230 an ad hoc demand 232 and converts 234 ad hoc demand 232 into a standard format as explained above. Ad hoc demand 232 can be captured via email with, for example, an EXCEL spreadsheet, or an EDI PO. Additional services, which were not specified in the customer contract, are also captured, such as expedited delivery, special labeling or packaging. Unlike with a regular customer forecast, a field is established (not shown) to identify the ad hoc demand to track order billing information. This field may optionally be used to generate an additional charge for ad hoc orders. If there are problems in converting the customer demand to a standard format, an error routine 236 is performed to cure all technical difficulties. In a preferred embodiment, all such technical difficulties should be resolved by the end of the business day.

Thereafter, a delay circuit 238 ensures all the converted demands are stored and the required functional validations are performed by the end of the business day. A collect customer information circuit 240 performs the validation by compiling the converted customer's demands and comparing them with customer contract 214 and customer product information 213.

A validation circuit 244 determines whether the converted demands are valid. Validation circuit 244 detects, for example, whether the demanding customer is actually a customer of supply chain server 70. Validation circuit 244 also detects whether the requested part number is a valid part contracted between customer 72 and supply chain server 74. Unlike with a normal forecasted demand, no validation is necessary to determine if ad hoc demand 232 is complete as it is an unforecasted demand and can include either one or more customer part numbers.

If validation circuit 244 determines that the customer demand is not valid, an error routine 246 is performed where a notification is sent to the Account Manager to resolve the outstanding issues. Supply chain server 74 then sends customer 72 an exception notification to inform the customer that the demand was incomplete in some way. The exception notification itself is stored in a suspend file. If valid, the system continues to the next Planning step.

In this way, the Planning Module of supply chain server 74 uses a forecast system, which can replace the purchase order system that was used in the prior art. In prior art supply systems, suppliers did not see forecasts and could not determine whether a forecast was contrary to a contractual agreement or whether there was an undesired error in the forecast. The supplier only saw what a particular customer gave the supplier. Even if the supplier used an MRP system, MRP demands frequently vary significantly and suppliers did not have the ability to review these demands to ascertain unusual or unexpected requests. Suppliers thus often used replenishment algorithms to replenish their stock as there never was certainty as to the expected amount of depletion of the stock.

The invention overcomes these problems by reviewing the customer forecasts for consistency with contractual agreements and with prior forecasts. The invention thereby enhances continued delivery and performance, thus reducing the amount of undesired scrap material produced when suppliers have excess inventory. Suppliers benefit from the supply chain network architecture of the present invention because demand volatility is minimized. This is due to the accumulation of the demand forecasts and filtration systems reviewing the demands. Suppliers can also replenish their inventories with more certainty as they are now given a forecast of customer demands from many customers a few weeks in advance. In high volatility demand industries such as demands for electronic components, prior art supply chains could not work based upon customer forecasts because a 50% change in demand from one week to the next was possible. As prior art supply chains took too long to deliver a product to a customer, they could not keep up with these highly volatile demands. The supply chain architecture of the invention, however, enables much quicker delivery (e.g., within one week) so that forecast-based customer demands are possible.

Although not required by the planning process, mid-tier customers, for example, may encounter planning restrictions that are imposed by suppliers. Such restrictions may include a requirement to utilize purchase orders, and a “frozen window,” typically four to six weeks long, during which orders can not be altered. According to such supplier restrictions, once a purchase order is made it is locked in, and no changes to the order are allowed. Although the preferred embodiment of the present invention obviates the need for purchase orders and is much more flexible than prior art systems, some order flexibility nevertheless is allowed under the present invention by way of order swapping and other planning activities by the supply chain server to provide options that otherwise would not be available.

The long term planning function of the supply chain network 70 may be performed manually since it does not need to be performed on short notice or with high frequency. Short term planning, within manufacturing and materials procurement lead times, however, should be automated as it is performed very frequently. The results of the short term planning should then be executable within a matter of hours or minutes, with great accuracy. Otherwise, the plans may no longer apply to the fast-paced change characteristic of many markets today.

As discussed above, in a preferred embodiment, each week, customers 72 submit a thirteen week demand forecast for each of the parts customers 72 will need over that time period. In the Planning Module, supply chain server 74 analyzes these forecasts and the demands are consolidated, translated into supplier part numbers, and transformed into specific supplier requirements. Supply chain server 74 achieves this transformation via demand aggregation, rough cut capacity matching and supply plan optimization. Server 74 may also extrapolate forecasts based on expected demand and historical data from customers 72.

Supply chain server 74 performs aggregation by accumulating demand for products made using the same or similar supplier manufacturing processes. Since customers, and often suppliers, like to assign different part numbers to the same or similar products, aggregation by trying to match identical part numbers is generally ineffective. As suppliers aggregate customer orders into Master Planning Units (MPUs, sometimes also referred to as Master Planning Families), to schedule their internal production facilities, supply chain server 74 uses these same supplier defined MPUs to perform its aggregation.

Supply chain server 74 performs rough cut capacity matching by first assigning aggregated demand to particular suppliers that customers 72 have determined as their preferred suppliers. Each customer 72 will have its own definition of a preferred supplier and supply chain server 74 retains this information in its data banks for each customer part number. Supply chain server 74 tests to see if this default assignment of demand to each preferred supplier falls within the supply capacity constraints given by suppliers 76. Any demand on a given supplier in excess of the supplier's capacity constraints is re-assigned by supply chain server 74 to another supplier, based on customer second-choice preferences or other algorithms the network uses. Supply chain server 74 uses this iterative approach to determine a rough cut allocation of demand to the available supply.

Supply chain Planners may be used to review the rough cut capacity match to determine if any intervention is required for supply chain optimization. Since supply and demand of many types of components are very volatile and change on very short notice, Planners may wish to intervene to make manual adjustments to the rough cut capacity match. As an example of such an intervention, often suppliers of leading edge components suffer from periodic yield problems where they cannot produce their stated capacity for some period of time. In such an instance, supply chain server 74 will be informed by a supplier, through an electronic message, telephone call, or an advanced ship notice (ASN), that fewer parts than expected had actually been shipped. Supply chain Planners use extensive information available to them on the Supply chain network 70 to decide how best to re-allocate demand products, either by manually over-riding the system, or by entering new parameters into the system. This results in some demand reduction at the impacted supplier and increased demand at other suppliers. Thus, supply chain network 70 can be controlled so the Planner can feel more secure that all the supply chain network's customers will receive their parts as expected. Similarly, it sometimes may be in the customer's best interest to allocate some demand to a non-preferred supplier in order to foster a more competitive market-place, and the supply chain Planners may shift some demand to optimize supply chain network 70 in this way.

The result of supply chain optimization is a Supply plan that effectively meets all customer demand within the suppliers' capacity constraints. The demand/supply matching process may be executed on a daily basis during week 0 for certain volatile commodities (e.g., DRAM). After confirming their ability to support this plan, suppliers are ready to execute the week 0 demand and initiate the Logistics process in the Logistics Module. Suppliers may also be required to follow defined production or inventory management protocols relating to demanded products.

On occasion, a customer may place an ad hoc order with supply chain server 74 for quantities of material not originally included in the customer's weekly forecast. In such an event, capacity availability to support the new demand is investigated by Planners. The Planner identifies, when possible, source(s) for the new request and initiates the fulfillment process in the Logistics Module.

If a supplier 76 is unable to meet its commitment (short shipment), the Planner may act as an intermediary between the customer and supplier to resolve the situation. If necessary, the Planner will identify alternative sources of supply and restart the Logistics Module. If material is returned to the supplier and replacement parts are needed at a later date, the Planner adjusts future demand to reflect the need for the replacement parts.

The transactional nature of these processes provides supply chain network 74 with information critical to some of the value added services it may offer. This information includes: customer/industry buying patterns, customer forecast accuracy, supplier performance, and product transitions. Such information may be made available as is discussed in the Network Management section below.

Demand

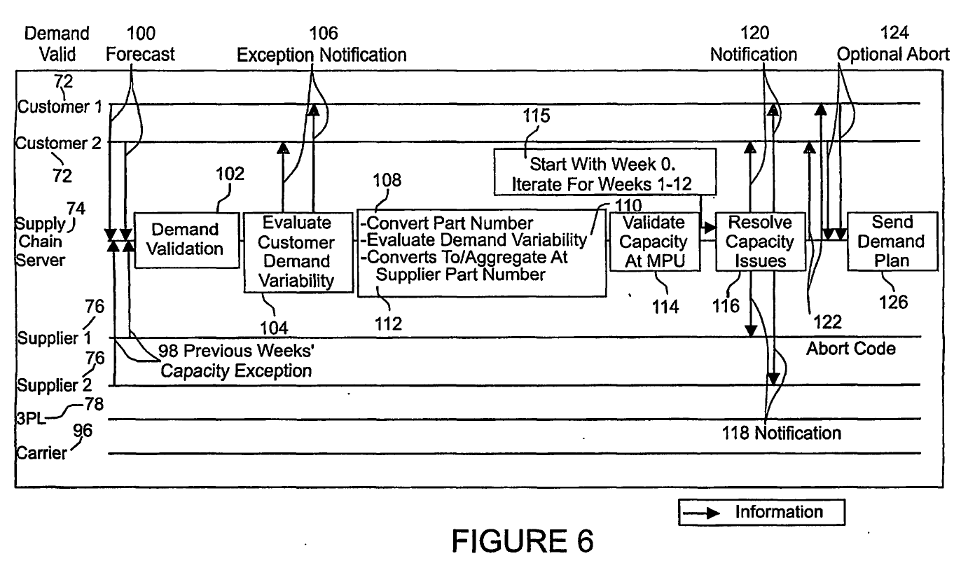

Referring to FIG. 6, there is shown the flow of information during the Demand phase of the Planning Module. A plurality of customers 72 (two are shown in the figure), a plurality of suppliers 76 (two are also shown), a 3PL 78 and a carrier 96 are connected to supply chain server 74. Starting with the clean, validated forecast files, a total demand picture is developed using customer part numbers. Then a demand plan is generated based on supplier part numbers corresponding to the customer part numbers. The demand plan is aggregated and the corresponding forecast is sent to the suppliers.

The Demand phase of the Planning Module begins with suppliers 76 sending previous weeks' capacity exceptions 98 regarding supply shortfalls and receipt of valid customer forecasts 100 to supply chain server 74. Valid forecasts 100 are adjusted to take into account previous weeks' returns which were not immediately replaced and not yet reflected in the forecast. Supply chain server 74 receives these inputs 98, 100 and performs a validation 102 of the demands made in forecasts 100.

Supply chain server 74 then performs an evaluation 104 of the variability of forecasts 100 and issues exception notifications 106 when the variability of the forecasts does not conform to defined parameters. An overall demand picture is generated based on customer part numbers (CPN).

The customer part numbers requested by customers 72 then are converted 108 based on a table to a supply chain part number. An example of such tables can be found in co-pending application Ser. No. 09/704,643 filed on Nov. 2, 2000 for a SYSTEM AND METHOD FOR GENERATING A CROSS REFERENCE GUIDE, the entirety of which is hereby incorporated by reference. Supply chain server 74 evaluates 110 the demand variability of supply chain network part numbers. As with customer number evaluation 104, supply chain server 74 determines the overall demand variability. This calculation is useful in that, even though each individual customer may avoid exceeding allowed tolerances, the aggregation of all customer requests may exceed total supply especially if many customers order close to their allowed limits. Such ordering may cause overall depletion of suppliers' products which may take some time to restore. The supply chain network part numbers are then converted 112 to corresponding supplier part numbers (SPN).

According to a preferred aspect, the capacity of suppliers 76 is validated 114 to determine if there are any capacity issues involved with the forecasts 100 of customers 72. As is indicated at 115, this process starts with the current week 0 demand and iterates through the week 12 demand. Any capacity issues are resolved 116 by sending a notification 118 to suppliers 76 and a notification 120 to customers 72. The availability of this aspect will be determined in part by supplier willingness and ability to provide capacity information.

As an alternative option, customers 72 may also receive an abort code 122 which enables customers 72 to abort 124 part or all of forecast 100. Abort options will not be available within frozen windows, for example, and may not be available at all to certain customers depending on supplier requirements and contractual agreements.

Supply chain server 74 then resolves all demand issues and sends the demand plan 126 to suppliers 76.

In the event of an optional abort, control branches to Logistics Module 44 of FIG. 11A. Such an abort would then be displayed if the customer accesses its account through supply chain server 74 so that the customer knows that the order for the particular parts was aborted. The processes described above will now be explained in detail by way of an example.

Supply Commitment

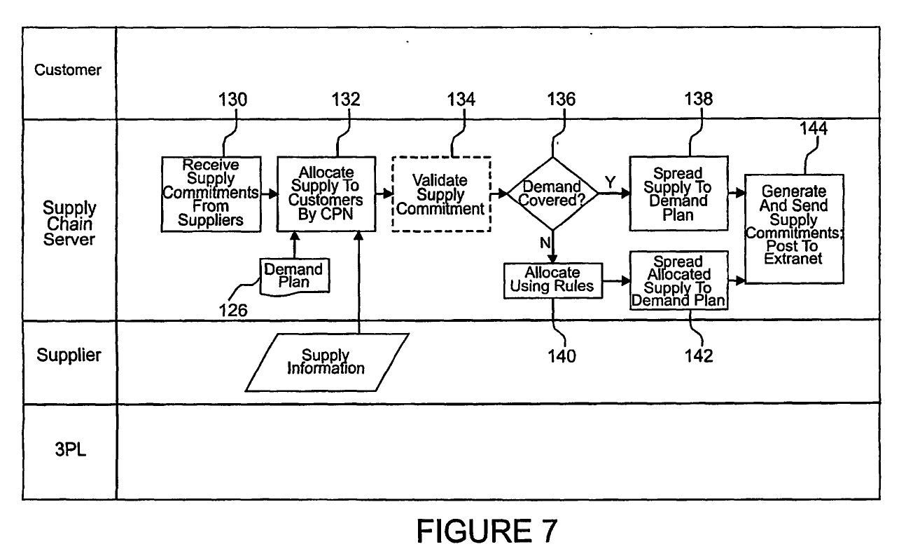

Referring to FIG. 7, the processes performed by supply chain server 74 during the Supply Commitment phase of the normal planning scenario are shown. After the demand plan has been generated and sent to the suppliers, supply chain server 74 receives supply commitments 130 back from the suppliers in response to the demand plan. The supply then is matched to the demand initially by allocating the committed supply to all customer locations by customer part numbers 132. Allocation is based on minimum package quantities (MPQs).

Supply Validation

Supply chain server 74 optionally can validate the supply commitments 134. Validation is based upon the capacity of suppliers 76 and contractual provisions between supply chain network 74 and suppliers 76. These contractual provisions relate to any contractual capacity or supplier freeze horizons which may be enabled based upon the consolidated demand file. Availability of the data necessary to perform this validation will depend on supplier willingness and ability to supply the information.

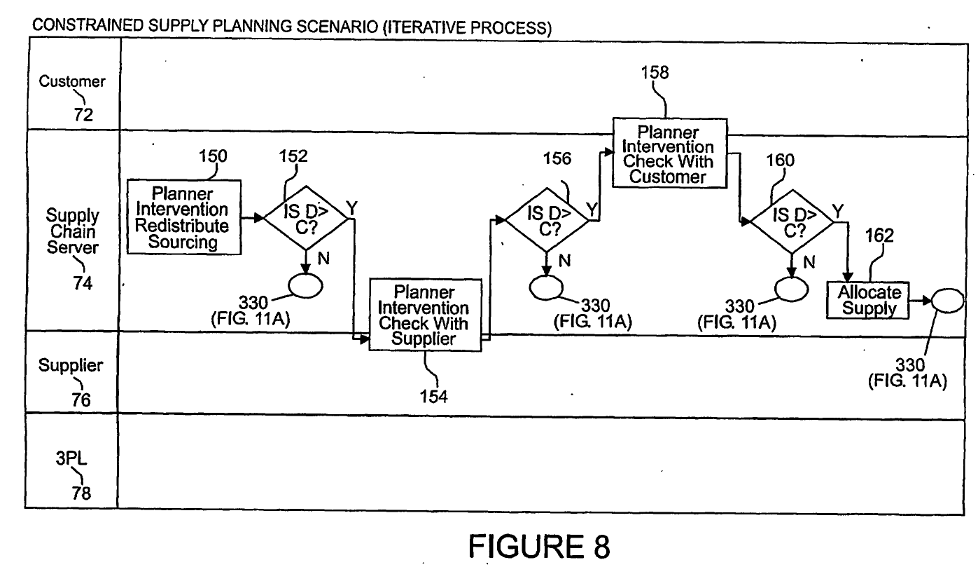

The supply network server then determines if the demand is covered 136. If yes, the supply is spread to the demand plan 138. If not, allocation rules are applied 140 as in FIG. 8, for example. The allocated supply then is spread to the demand plan 142. The completed demand plan is generated and sent to the customers 144. In a preferred embodiment, the demand plan is posted to the extranet.

Constrained Supply

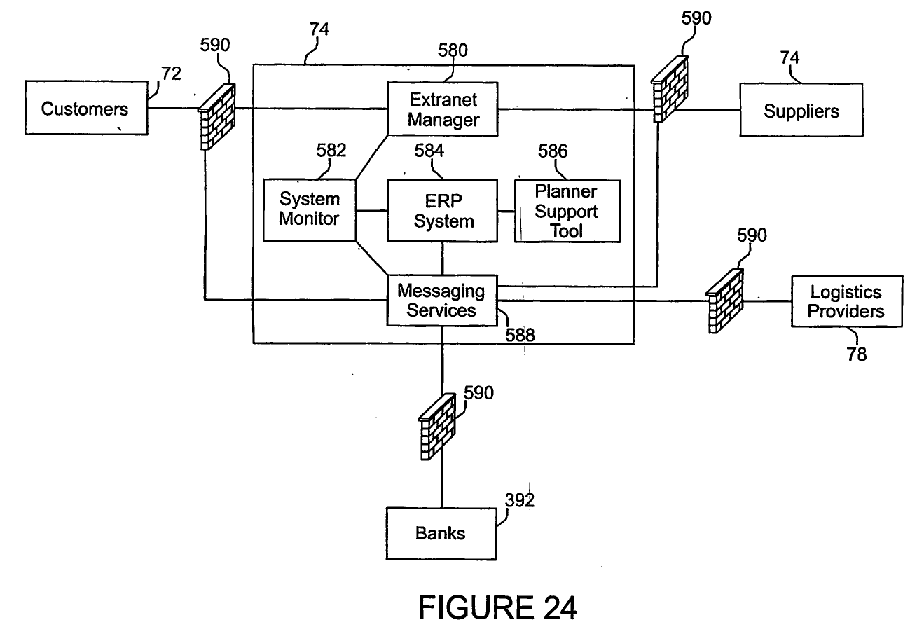

Referring to FIG. 8, a constrained supply planning routine first redistributes 150 the customer demand in an attempt to ensure that there is no resultant imbalance between demand and supply. This redistributing is performed using an iterative process and a Planner using the Planner Tool (explained below with reference to FIG. 24) to determine alternate sources of supply in light of the suppliers' capacity and contractual frozen horizons. Supply chain server 74 then queries 152 whether the new resultant demand is greater than the suppliers' capacity. Again, if the demand is not greater than the capacity, supply chain server 74 branches to 330 in the Logistics Module. Otherwise, supply chain server 74 branches to supplier intervention 154. At supplier intervention 154, supply chain server 74 communicates with suppliers 76 to ascertain the situation causing the supplier's capacity to not equal the demand (e.g. raw material constraints or burst capacity issues) and evaluates possible alternatives (e.g. the potential to build ahead or store for future capacity increases). This may produce a new supplier capacity.

After contacting the supplier in supplier intervention 154, supply chain server 74 queries 156 whether the new capacity is less than the customers' demand. Again, if the demand is not greater than the capacity, supply chain server 74 branches to 330 in the Logistics Module. Otherwise, supply chain server 74 branches to customer intervention 158. In customer intervention 158, supply chain server 74 communicates with customers 72 to ascertain any possible customer flexibility (e.g. part substitutions, early or postponed delivery) to thereby produce a new customer demand. After contacting the customer at customer intervention 158, supply chain server 74 queries 160 whether the new customer demand is greater than the suppliers' capacity. Again, if the demand is not greater than the capacity, supply chain server 74 branches to 330 in the Logistics Module. Otherwise, supply chain server 74 branches to an allocate supply routine 162.

In allocate supply routine 162, the parts which actually are available from suppliers (“constrained parts”) are allocated equally among the demanding customers and the forecasts of the customers are altered accordingly. In such an event, all demanding customers may receive an equal amount of the constrained parts, or the demanding customers may receive a pro rata share of the constrained parts based upon how many parts a particular customer requested in relation to how many parts other customers requested. Thereafter, supply chain server 70 branches to 330 in the Logistics Module.

Commitments on Ad Hoc Customer Demands

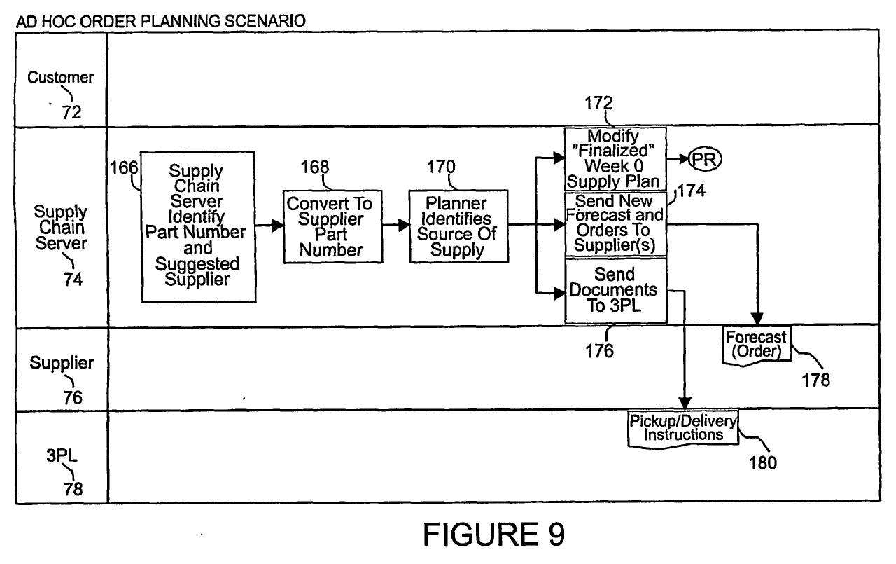

Aside from the normal planning scenario performed by supply chain server 74 in response to customer forecasts, as was detailed in FIGS. 7 and 8, the Planning Module can also process ad hoc customer demands. Referring to FIG. 9, there is shown the processes performed by supply chain server 74 in response to an ad hoc demand from customers. As with a typical order, supply chain server 74 receives a customer demand file. The demand file is then analyzed 166 to identify corresponding supply chain server supply numbers and suggested suppliers to provide the parts corresponding to the supply chain server supply numbers. The supplier identification is based upon contracts negotiated with the customer regarding preferred suppliers as was explained above. In analysis 166, a unique identifier is assigned to represent the demand for each part from each customer during each week.

Supply chain server 74 then converts 168 the supply chain server supply number of the demand file into corresponding supplier part numbers. This conversion can be done using the customer part number as well. Thereafter, in an identification circuit 170, supply chain server 74 communicates with suppliers 76 and identifies various suppliers who may be able to provide an alternate supply for the ad hoc demand.

Thereafter, supply chain server 74 modifies 172 week 0 supply forecasts to produce a modified forecast 178 that reflects new quantities for both suppliers and customers. The modified week 0 forecast is also sent to the Logistics Module discussed below. Supply chain server 74 sends 174 modified forecasts 178 to suppliers along with a unique identifier assigned to represent a specific week's demand for each supplier—similar to a purchase order number. Finally, supply chain server 74 sends 176 documents 180 to 3PL 78 including pickup and delivery instructions for the ad hoc demand. The ad hoc demand orders will be sent directly to the customer and will generally not be sent through the cross dock described below.

Thus, by receiving and processing customer forecasts from a plurality of customers, and evaluating these forecasts with respect to an aggregation of suppliers' capacities, the Planning Module can produce a more effective and useful supply plan than that available in the prior art. Moreover, as the network is in contact with a plurality of suppliers, the Planning Module can shift allocation of customers' demands among suppliers to ensure that these demands are satisfied.

Order Management

Order Management begins with the creation of customer sales orders. From there, consolidated supplier purchase orders are generated. Orders optionally can be acknowledged. Exception processing includes unplanned orders and shortages, past due order management, sample orders and data sheets, and returns.

Create Sales Orders

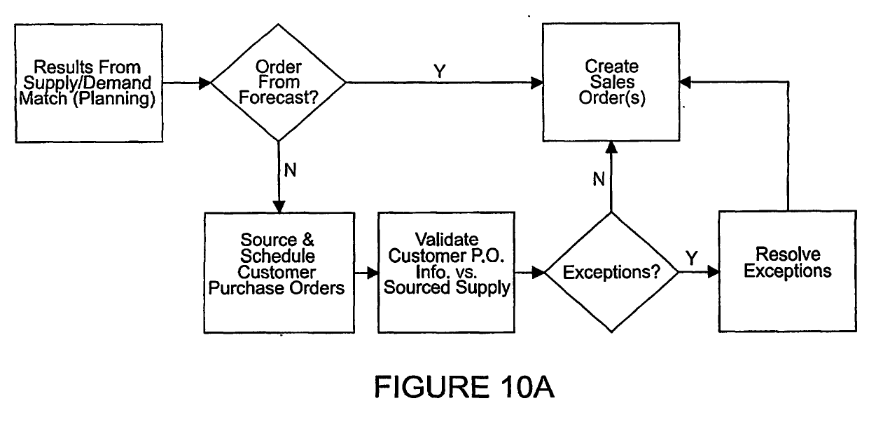

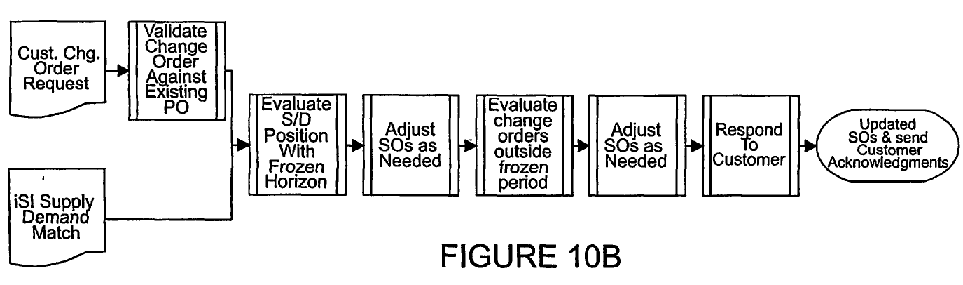

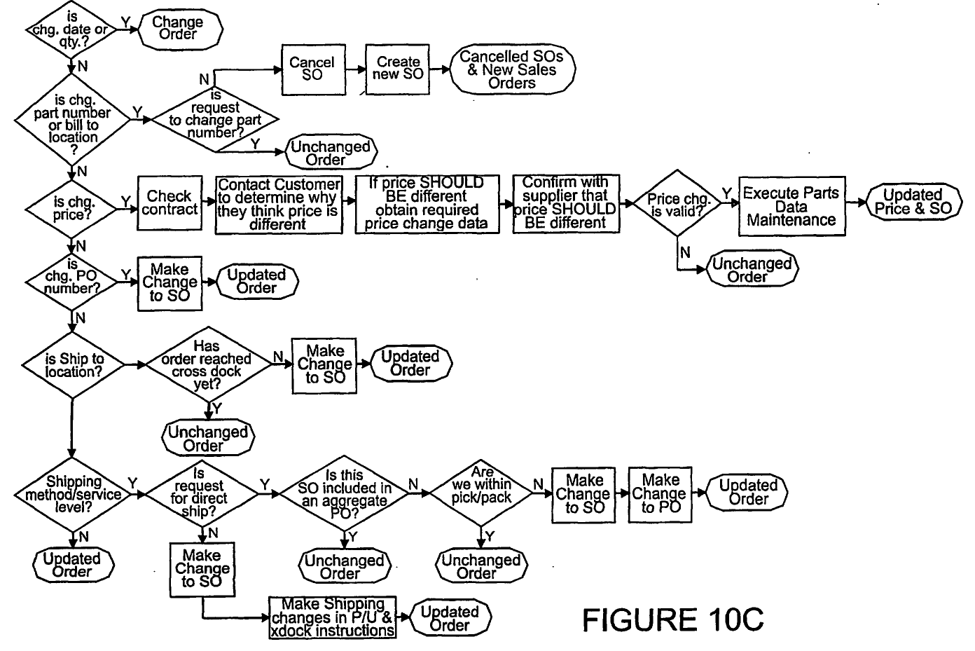

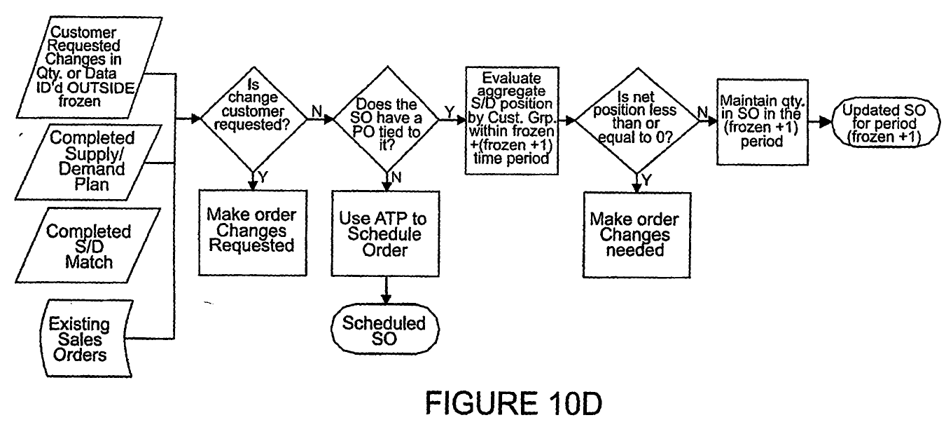

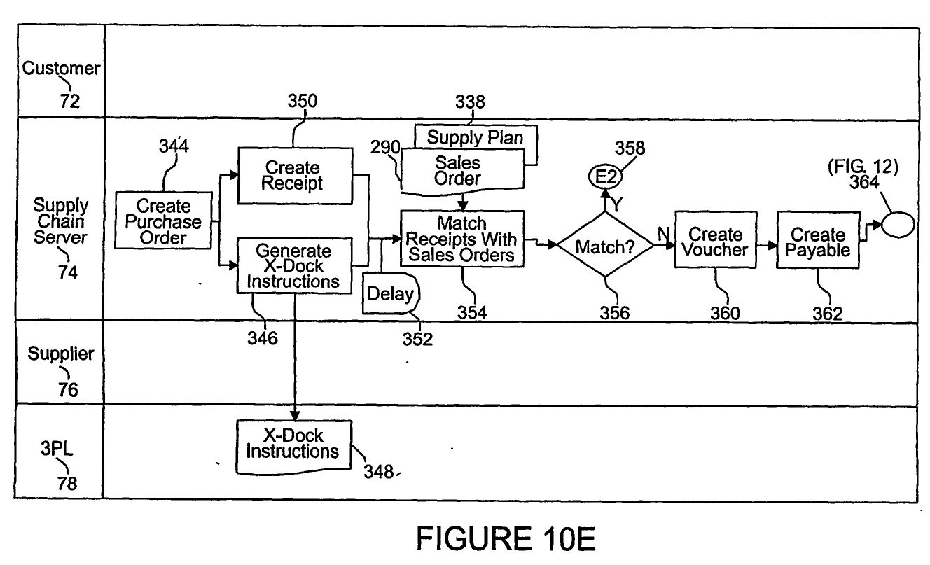

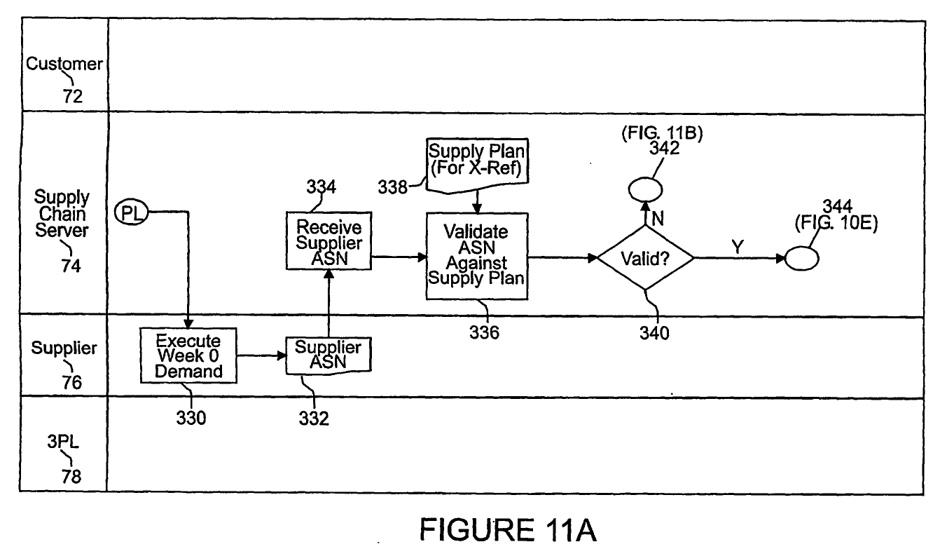

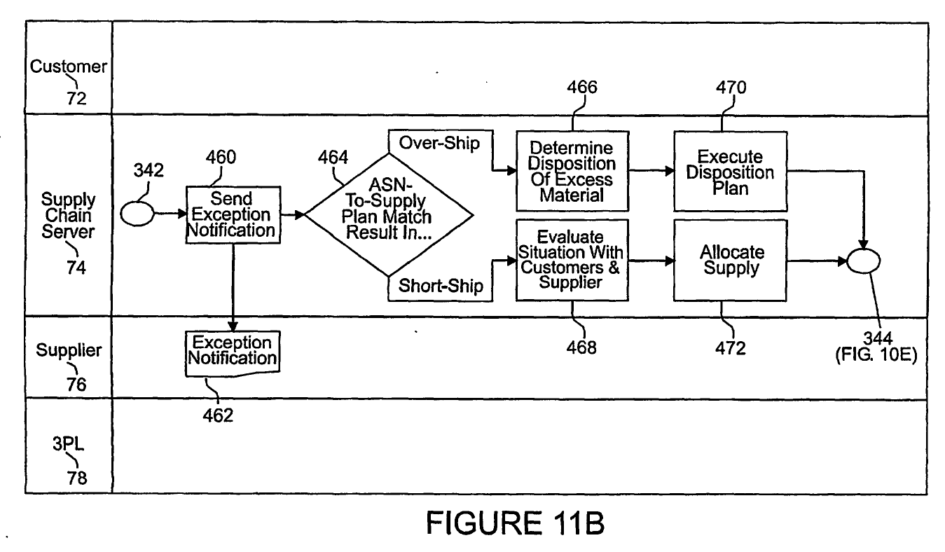

Referring to FIG. 10A, a schematic for the process of creating sales orders is shown. The network server receives demands from the clean, validated demand data 126 (FIG. 6) and the results of the supply demand match (FIG. 7). A determination is made as to whether new sales orders must be generated to support new demand requirements. If so, new sales orders are created.

The process begins when clean, validated demands are received or the results of a supply demand match require generation of a sales order to support new demand requirements. A sales order will be created when the results conclude that demand is greater than the existing open sales orders, for example for a given week at frozen window. Frozen windows can include lead time for Build to Order (BTO), four weeks frozen, 0 week for pull. Sales orders will be grouped by customer ship-to. One sales order can have multiple sales order lines. When the same part is being sourced from two different suppliers, two different sales order lines will be created.

Sales orders require a customer purchase order number, a ship/to/bill to location, a branch plant (default cross-dock location), supplier part number, customer part number, quantity (by minimum pack quantity (MPQ)), price, customer request date, transportation service level, promise date, and any special customer requirements.

According to a preferred embodiment, sales orders generated from forecasts will be created immediately from supply demand match based on an existing frozen window. Customer initiated purchase orders will be processed at the end of each business day. Although new demand can be received at different times, it preferably is processed only once daily.

The process of determining the orders needed begins at the frozen window for a given supplier or device, and after the supply/demand match has been completed. If the customer is the type for which orders are converted from forecasts, a blanket purchase order (BPO) must be signed. If no BPO exists, a purchase order must be provided prior to the frozen window in order to confirm. If no purchase order is received, ATP (available to promise) will be released at the frozen window and a sales order for that customer will not be created for the current period.

The frozen window may differ by supplier and by device and/or lead time. The frozen window would include, for example, lead time for BTO. A four week frozen window is typical, and can vary by supplier and by device. Sales orders are created based on supplier part numbers, quantity, customer request as defined in the supply plan.

Demand that is uncommitted or exceeds supply is handled through a source and schedule process. The supplier that will fill the demand is identified. Customers submit orders that need to be sourced and scheduled in order to create sales orders. The process begins when the network server receives customer purchase orders.

In the appropriate time bucket, the customer purchase order data is compared to the S/D match by customer part number. Specifically, the customer PO order quantity is compared with allocated ATP for that CPN from the S/C match and simultaneously compare from the customer PO to the existing POs. If customer purchase orders are consistent with supply/demand results, i.e., CPN, CRD, and quantity match, then the sales order will be sourced from SPN identified in the Supply Plan. The sales order will be scheduled with the commit date of the week in which the supply is committed.

If demand is not consistent with supply/demand results, i.e., CPN, CRD, and quantity do not match, then, if demand quantity is less than the supply plan, the sales orders will be sourced form the SPN identified in the Supply Plan. It is possible that one CPN can be sourced from multiple SPNs in the Supply Plan. Therefore, a check is done to confirm that all supply is allocated to the given CPN regardless of which SPN the supplier is being sourced from.

If demand quantity is greater than supply plan, order will be sourced for the SPN and quantity in the S/D match and scheduled for the week in which the supply was committed. For the additional quantity requested, attempt to source the non-committed demand based on the customers supplier preference profile. Attempt to fill uncommitted demand with ATP for the current week from the customers first supplier preference. If no ATP exists for preference one, then look at preference two, then three, etc. If no ATP exists in the current week, continue to look for ATP in subsequent weeks. Once a preferred source and a period of supply are identified, the customer purchase order information can be validated.

When ATP is used to schedule orders, allocated and unallocated ATP numbers from the network server supply/demand match are looked at to schedule order based on best available date. Allocated ATP is scheduled and consumed first, since this quantity already has been committed to the customer. If allocated ATP is insufficient to cover demand each period, unallocated ATP is consumed. The rule for consuming ATP preferably is LIFO. If supply for the excess demand cannot be allocated within 26 weeks, the customer is notified and the process ends. No sales order for the additional quantity is generated.

Customer purchase orders are validated by verifying the data. Exceptions are identified and the process is stopped for their resolution with the customer. Once all purchase orders from customers and order to forecast data has been validated, sales orders are generated. For customers on a credit hold, sales orders are generated but must be flagged or otherwise labeled as to the credit hold. Import/export restrictions, exceptions handling, CPN/SPN, ship to location, and sold from location are checked against master data files. If any invalid combination is identified, an exception is created for resolution with Logistics. A transportation service level is assigned, based on the default customer profile. Preferably, sales order information is posted to the Extranet for viewing by each customer.

Sales Order Maintenance

Referring to FIG. 10B, a schematic shows the process of maintaining sales orders according to the present invention. During the process change order requests are received from customers and evaluated. Where feasible, change orders are accommodated with appropriate changes to sales orders, and the customer is notified accordingly. In addition, change orders required by the demand plan process are identified, and again, sales orders are changed appropriate to accommodate the identified needs.

The process includes maintaining orders generated from forecasts as well as those submitted by customers. The network server identifies where change orders are needed as a result of the demand plan process or change orders received from customers. The process begins when a change order request is received from a customer, when the aggregated demand plan (FIG. 7) has been created and results must be compared against current SOs to determine if SO maintenance is required, or if S/D match is complete and unallocated ATP is identified so that SOs that do not have an associated PO can be rescheduled.

SO data elements can be changed when there is no corresponding PO, or when the corresponding PO is outside the frozen time fence for a supplier (except for part number, which requires a cancel and create new).

Change to SO quantity, or date/transportation service level changes that would lead to a change to the network server request on the corresponding PO cannot be made when the corresponding PO is inside the suppliers “frozen” time fence (or pick/pack lead time if there is no frozen time fence. (If multiple SO lines can be modified to result in no “net change” to the corresponding PO line, such a change is allowed.)

Changes to SO logistics routing that will change the PO ship-to (e.g., cross-dock to direct-ship), or any change that will impact the packaging and/or labeling requirements for the corresponding PO cannot be made inside the supplier pick/pack lead time.

Changes to SO ship-to, outbound leg transportation service level (cross-dock to customer location) and impacted dates cannot be made once the corresponding PO line has been received at the cross dock, absent an ability to contact the 3PL and make accommodations for an override.

As a result of the process, updated SOs, customer SO acknowledgments, and updated POs are generated. The customer SO acknowledgment and updated POs are conditional because this may require PO sent to the supplier and acknowledge back from the supplier prior to sending the customer an acknowledgment.

Once a customer change order request is received, it is validated against an existing Sales Order. If no corresponding SO or purchase exists, an exception is generated and sent to the customer.

FIG. 10C is a process flow detailing the types of change order requests that can be received by the supply chain server. Changes are handled differently according to the process flow and applicable business rules which determine whether or not sales orders are updated.

For example, if a change order request is to change the customer request date (CRD) or quantity, including a cancellation request, the change is made and the process continues as shown in FIG. 10B, and the supply/demand position is evaluated within the frozen horizon. If the change order request is to change the bill-to location, the sales order is canceled and replaced by a new sales order, which is identical except for the bill-to location. Requests for price changes are verified with the customer and validated with the supplier. Requests to change purchase order numbers are updated internally with the supply chain server.

If the change order request is to change a ship-to location, no change can occur if the order already has reached the cross-dock location, and the order remains unchanged. Otherwise, the sales order is updated with the new ship-to location, and import/export compliance is re-checked. Requests to change the shipping method or service level also are handled based on the status of the order.

Orders that have been changed are captured and an order acknowledgment is generated. Orders that are not changed generate a corresponding communication of no change to the customer.

Referring again to FIG. 10B, the process step of evaluating S/D position in the frozen horizon involves comparing existing sales orders with quantity and date change requests identified, as well as with the completed demand plan picture. Within customer groups, by part number, within the same period, identification is made as to where demand can be swapped from one customer to another on their respective sales orders without impacting the correlated purchase order(s).

The supply/demand position is evaluated beginning with the demand. The total incremental demand (i.e., change orders for increased quantities or increased forecasts) inside the supplier frozen horizon is summed for four conditions: Customer submitted change requests, order-from-forecast change requests, SOs with no PO, and SOs with promise dates that are greater than the CRD.

The supply is evaluated by summing the total “excess” supply within the suppliers frozen horizon, including commits to specific PO within the frozen horizon that are greater than the customer required quantities due to a change request for decreased quantity (i.e., instances where the sum of supply commitments on existing SOs is greater than the sum of the demand within the frozen horizon by CPN and ship-to.) The summing of the excess supply should be done for the entire frozen period; however, when determining specifically when the excess supply can be allocated, it should be determined by period so that supply is allocated in the correct period it is available. Also included is ATP inside frozen period from supply/demand match.

Where sales orders (demand) have the same SPN, price, package, reel labeling, revision number, ship-to location (i.e., same cross-dock), shipping service level, part marking, special requirements, and sold-to customer, sales order quantities and dates can be swapped from one SO to another. Also, it is possible to swap some, but not all, of the demand in a case where only a portion of the change requested can be accommodated. Prioritization in terms of which demand to fill first should be by receipt date, request date, and historical usage. If any of the above is not the same from one sales order to another, sales order quantities and dates cannot be swapped, and the corresponding change order requests cannot be accommodated.

Referring to FIG. 10D, supply/demand also can be evaluated for orders that exist outside the frozen window. The change can be made on requests by customers for changes in quantity and/or date. Changes also can be generated by the supply chain server by comparing the demand plan to existing sales orders. The supply/demand position is calculated within the frozen horizon plus the first period outside of frozen, and a determination is made as to whether and how the order should be maintained. Sales orders outside the frozen window with no corresponding PO are rescheduled with an effort to improve the promise date.

Sales orders then adjusted again as needed, and responses are sent to requesting customers.

Receive and Process Purchase Order Acknowledgments

Acknowledgments are received from suppliers for Purchase Orders (POs) sent to them by the supply chain server. Once the PO Acknowledgment is received by the supply chain server, a validation process is undertaken to identify exceptions between the supplier PO Acknowledgment and the supply chain servers open purchase orders. Any exceptions are resolved.

The process begins when the supply chain server receives an order acknowledgment from the supplier. Preferably, the acknowledgment is received within 24 hours of receipt by the supplier of the server PO. The order acknowledgment should contain, as a minimum, the server PO number, the server part number and/or the customer part number, the supplier part number, the ship-to location, the request date, the supplier promise date, the supplier quantity commitments for the corresponding promise date on the PO, part price, and supplier promised quantity. Validation includes identifying mismatches in these data fields between the supplier acknowledgment and the server PO.

The validation process includes receiving the order acknowledgment file transmission, translating the data into the server's format, performing file processing for validation and identification of exceptions, and resolving exceptions and updating server purchase orders as necessary. Exceptions would include identifying those server purchase orders for which no acknowledgment has been received, and acknowledgments received for POs that have been closed.

Exception notices are sent to the supplier to determine if an identified exception is a data error or intentional data input. Preferably, the exception is resolved by the supplier within 24 hours. Exceptions that are not resolved in response to a second notice can be escalated to supervisory attention and handling. A history is maintained of exception communications with each supplier.

Exception handling by the server will depend upon the discrepancy involved. Differences in order amounts, for example, where the amount committed is less than that requested, will allow the order process to continue. Allocation adjustments are made and purchase orders are updated, with uncommitted quantity kept on order, with notification to the customer. Where there is a discrepancy in part price, the order is stopped until the exception is resolved. When date discrepancies, greater than seven days for example, are identified, the process stops and no update takes place until the exception has been resolved.

Order Management Interaction

FIG. 10E shows the interaction between the Planning, Order Management, Logistics, and Payment processes. Referring to FIG. 10E, at step 344 a supplier purchase order is created based upon ASN 332, as described further below in connection with FIG. 11A. The purchase order is based on a customer sales order. The purchase order is created for each part for each supplier. Supply chain server 74 then creates 350 a receipt and generates 346 cross-dock instructions 348 based upon the purchase order 344. The receipt, like the purchase order, is organized by part and by supplier. Cross-dock instructions 348 may include pickup instructions for returns by customers. In situations of short shipment, cross-dock instructions 348 should reflect the Planner's allocations as discussed above. Upon receipt of a non-conforming shipment, 3PL 78 will notify supply chain server 74. A complete explanation of cross-dock instructions 348 is provided below in the discussion of the Logistics Module.

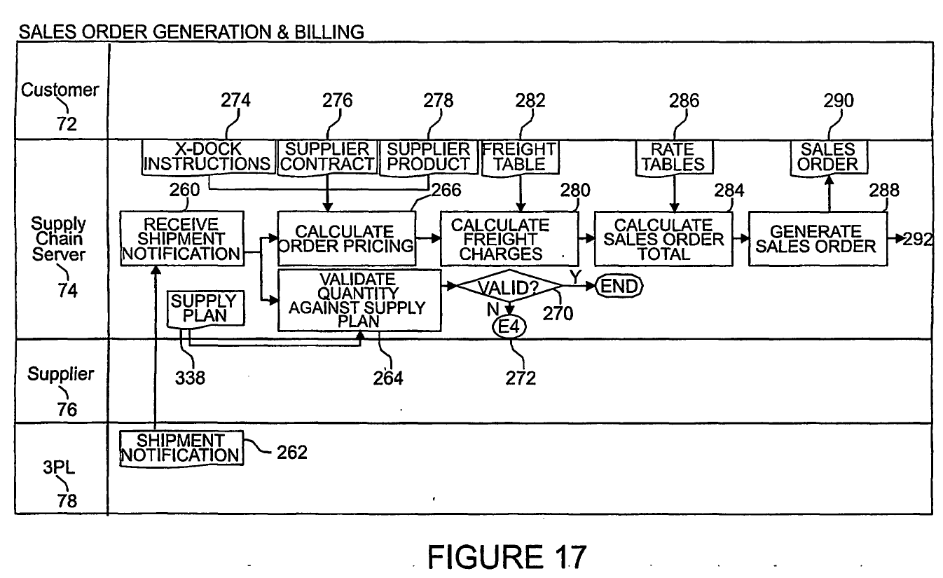

After an inherent delay 352 which insures that all week 0 demands are received and processed, supply chain server 74 matches receipts created in step 350 with supply plan 338 created earlier (See FIG. 11A) and sales order 290 discussed below in FIG. 17. Matching verifies that no material has been lost in transit. All sales orders that make up one purchase order should be created before the matching is performed. If the documents do not match at 356, an error routine 358 is initiated.

Error routine 358 handles various error situations. If receipts created at 350 are greater in number or price than sales order 290, possible causes of the problem include a delay in the generation of the sales order. If the receipts are less than the sales order 290 in either number or price, possible causes of the problem include a data-integrity issue, or material lost at the 3PL or in transit. In any event, the Planner should intervene. If the receipts created in step 350 match 356 supply plan 338 and sales order 290 at 356 then supply chain server 74 moves to steps 360 and 362 where a voucher and a payable, respectively, are created.

The supply chain network Order Management Module 42 is responsible for matching a source of suppliers 76 to meet customer demand and for initiating the Logistics Module 46. This capability also serves as a vehicle to capture vital, real-time data and generate Network Management information such as the following: industry trends, commodity/product trends, customer forecast accuracy, and supplier performance. This data and information constitutes the basis for many of the daily management reports and additional expert Network Management Services that supply chain network 70 offers to its suppliers 76 and customers 72, as described further below.

Customer credit history and approval may also be integrated as part of the Order Management Module. If the customer demand is valid, supply chain server 74 checks the credit status of the customer by referring to the customer's credit history. If the credit standing is not approved, an error routine is initiated where the Planner, the Account Manager and the Credit Manager attempt to form a resolution of the problem. All customer demands with denied credit are stored in a credit suspend file. If a customer demand is denied because of bad credit, a notification is sent to the Account Manager, the Credit Manager, and the Planner informing them of the customer's intent to buy.

Logistics and Fulfillment

Logistics

The Logistics Module executes the purchasing process. The focus of this function is on the purchase-to-pay cycle, including validation of the accuracy and timeliness of the order fulfillment process.

Additional areas covered by Logistics include communicating the supply order to suppliers (data interface) and reverse logistics. Reverse Logistics is the process of moving products from their typical final destination to another point, for the purpose of capturing value otherwise unavailable, or for the proper disposal of the products. The following is a description of a preferred embodiment of the Logistics Process.

Supply chain server 74 transmits a supply plan (including the week 0 demand) to supplier 76 via EDI, Web, email or other means. After supplier 76 executes the supply plan and 3PL 78 picks up the shipments, supplier 76 transmits an ASN (Advanced Ship Notice) to supply chain server 74. Each ASN typically includes one line item and is received electronically, containing all the necessary data agreed upon during the contract negotiation process. The ASNs are validated against the supply plan, and exceptions are resolved by the planner. Valid ASNs are used to generate cross dock instructions (which will be transmitted to the 3PL). In parallel, a receipt is created in an ERP system. Unlike prior art supply chains, the invention uses a supplier ASN to trigger the generation of a purchase order and a receipt notice indicating possession of the demanded part. This reduces a large number of steps performed in prior art systems because demand is conveyed to suppliers which is more likely to be fulfilled as it is based upon a forecast and not a purchase order.

All payments received from customers during each day are listed and consolidated by supply chain server 74 for each supplier 76. If payment for a specific order has been received from customer 72 via EFT (Electronic Funds Transfer), supply chain server 74 uploads the payment files to a bank and supplier 76 is paid (e.g., once per day). The release of payment information automatically updates the ERP. Additionally, the bank sends a confirmation to supply chain server 74 showing the payment information. If the payment is to be made via check, a remittance advice notice and the check are printed and sent to the supplier.

If a customer decides they would like to return materials procured through supply chain network 70, the customer contacts supply chain server 74 to obtain a return authorization. Supply chain server 74 includes pre-authorized return authorizations from suppliers 76, and agreed upon terms for accepting returns. The supply chain server sends customer 72 the authorization, and sends a copy to supplier 76. If supplier 76 has an established returns process, supply chain server 74 will send customer 72 return instructions. Once the supply chain server has the POD (Proof of Delivery) from the supplier's carrier 96, supply chain server 74 will debit the supplier's account and issue a credit to the customer. Any credits or debits are first applied to any open invoices from the supplier.

If the Supplier does not have an established returns process, once the authorizations are in place, supply chain server 74 sends pick-up instructions to 3PL 78 if necessary. A determination must be made (1) whether the supplier has replacement parts in inventory and (2) whether the customer needs the replacements immediately or if the replacement parts demand can be added to the existing forecast. If the customer needs replacement parts immediately, the supplier's available inventory is the preferred source. If no inventory is available, the replacement parts should be built and delivered to the customer on an expedited basis. If the replacement parts are to be added to the existing forecast, the planning process continues with the additional demand incorporated into the next thirteen week forecast (see Planning Module description). Again, once supply chain server 74 has received the POD from 3PL 78, supply chain server 74 will debit the supplier's account and issue a credit to the customer. Any credits or debits are first applied to any open invoices form the supplier, and then to the supplier account (to any open invoices). These processes will now be explained by way of example.

Referring to FIG. 11A, there is shown the flow of information during the Logistics Module in accordance with the invention. After supply chain server 74 completes the operations involved in the Planning Module, the week 0 (or current week) supply demand is sent to the appropriate supplier 76. Supplier 76 executes 330 the week 0 demand, issues a supplier ASN 332 and sends ASN 332 to supply chain server 74. Supply chain server 74 receives supplier ASN 332 at 334. In general only one line item is included in each ASN 332. The ASN information itself is in the supplier's part number. If the supplier's ASN accuracy percentage is poor, or the supplier cannot send ASNs, a packing slip is used instead.

Supply chain server 74 validates 336 ASN 332 against a supply plan 338 generated by supply chain server 74 in response to customer forecasts. If the ASNs do not match supply plan 338 at 340, indicating that what was delivered by the supplier did not match what was ordered from the supplier, an error routine 342 is implemented and suppliers 76 are notified. In such an event, supply chain server 74 will have contractual options to, e.g., cancel the balance of the partial shipment immediately, return shipment, etc. Otherwise, supply chain server 74 branches to step 344 shown in FIG. 10E.

Referring to FIG. 11B, there is shown an example of error routine 342 in accordance with the invention. Supply chain server 74 sends 460 an exception notification 462 to supplier 76 alerting supplier 76 of the nonconforming shipment. Thereafter, supply chain server 74 determines whether the comparison of ASN 332 and supply plan 338 results in an over-shipment or a short-shipment—outside of predetermined tolerances.

If the comparison yields an over-shipment, control branches to step 466 where supply chain server 74 determines the disposition of the excess materials involved in the over-shipment. This is performed by having the Planner discuss the situation with supplier 76 and relevant customers 72 to determine the appropriate disposition of the excess materials. Thereafter, supply chain server 74 executes 470 the resultant disposition plan and then branches to step 344 shown in FIG. 10E. Examples of the dispositions include returning excess material to the supplier, shipping the additional material to the customer (and adjusting any forecast as needed) or storing excess material at 3PL 78. Supplier 76 will be billed for any additional freight if the materials are returned to the supplier. Supplier 76 will also be billed any additional costs incurred in storing excess materials with 3PL 78.

If the comparison yields a short-shipment, supply chain server 74 evaluates 468 the situation by having the Planner communicate with supplier 76 and customer 72. This communication helps determine whether the short-shipment is merely a late shipment of whether the Planner must allocate further supply. The Planner may also discuss the situation with affected customers. Thereafter, supply chain server 74 allocates 472 to each customer a percentage of the available supply and control branches to step 344 shown in FIG. 10E.

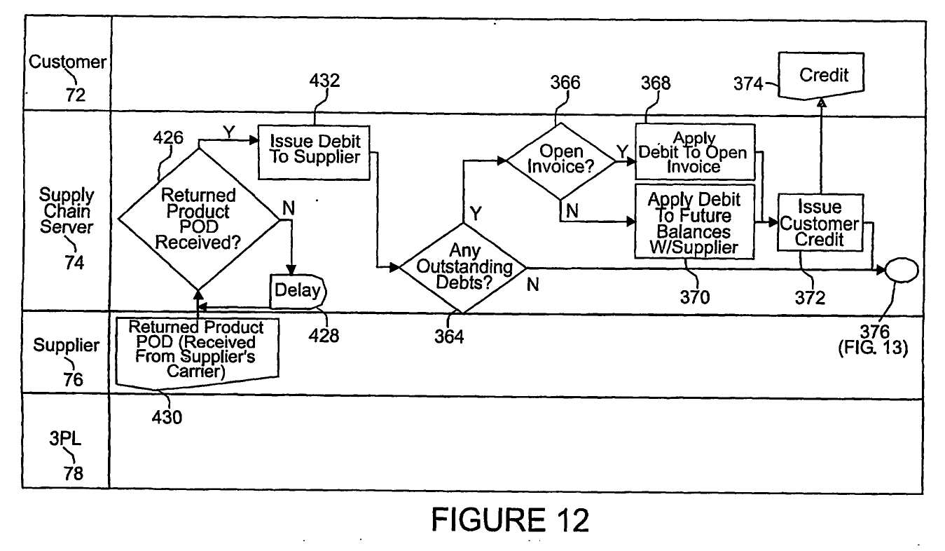

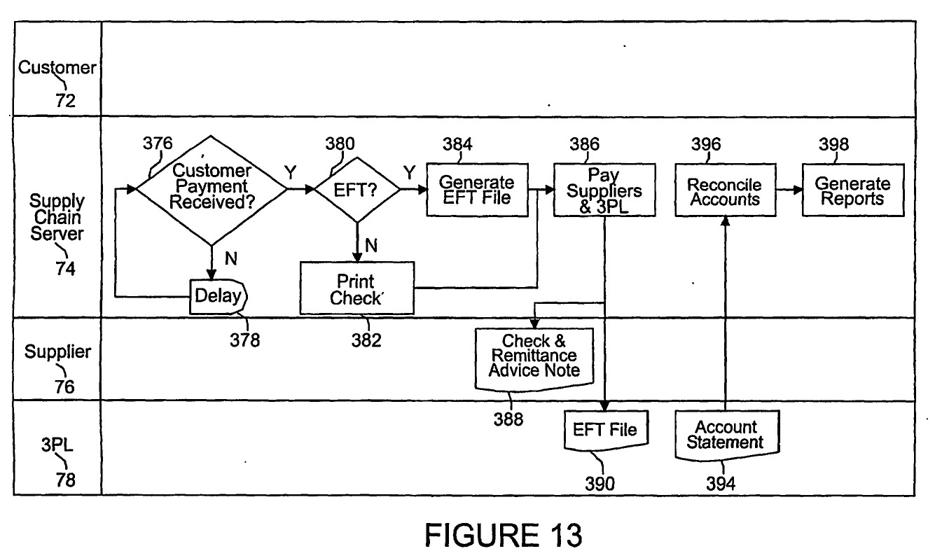

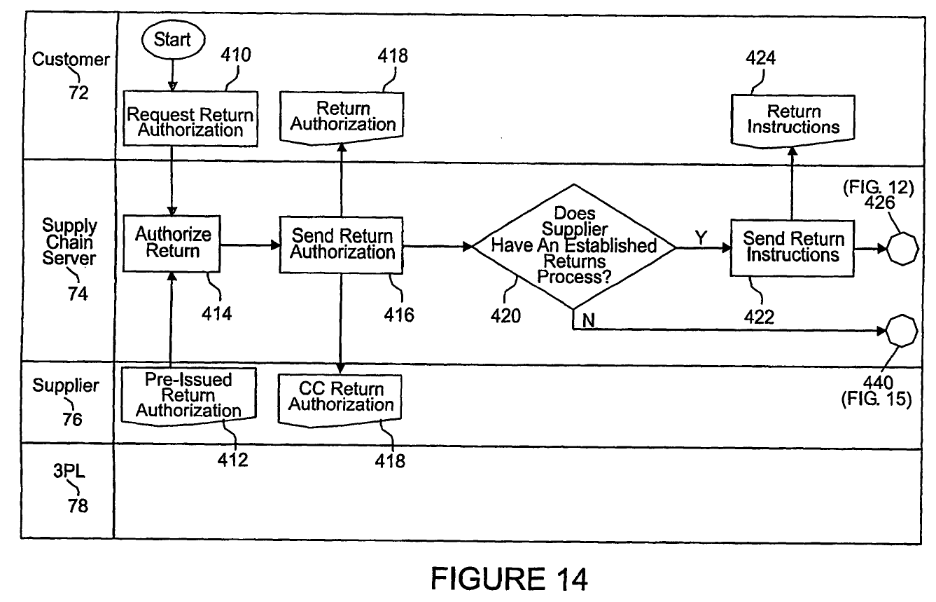

Supply chain server then branches, in FIG. 12, to query 364 and determines whether any debits (or credits) for the particular supplier are outstanding. If no debits are outstanding, control branches to step 376 (shown in FIG. 13). Otherwise, control branches to step 366 where supply chain server 74 determines 366 whether there are any open invoices for the particular supplier. If there are any open invoices, supply chain server 74 applies 368 the debit determined in step 364 to that open invoice and branches to step 372. Otherwise, supply chain server 74 applies the debit to future balances with the particular supplier and branches to step 372. At 372, supply chain server 74 issues 372 a customer credit 374 to customer 72. Thereafter, control of supply chain server 74 also branches to step 376.

Referring now to FIG. 13, at step 376 supply chain server 74 queries whether payment from customer 72 has been received. If payment has not been received, supply chain server 74 waits a delay period 378 and then continues to query 376 whether customer payment has been received. The supplier payment is thus delayed until payment is received from the customer. The customer payments themselves are aggregated throughout the day. When payment is received, control branches to query 380 which determines whether the payment is through an EFT. If the payment is not through an EFT, supply chain server 74 prints check and remittance advice notices at 382 and then branches to step 386. Otherwise, supply chain server 74 generates 384 an EFT file and then branches to step 386. The EFT information for a specific supplier is part of a master data file. An EFT payment is sent to each supplier at the end of each day (based on the aggregation of payments from received from customers throughout the day).

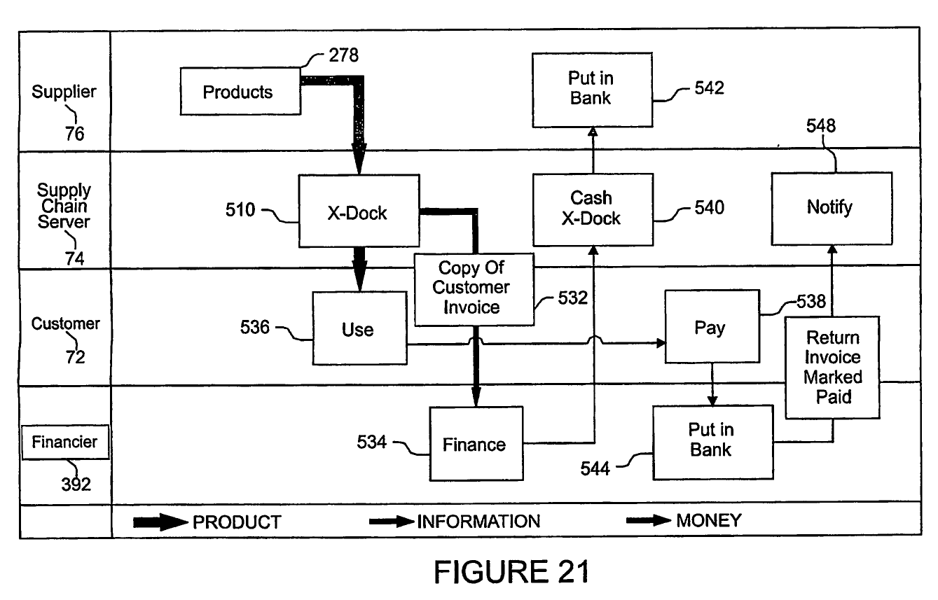

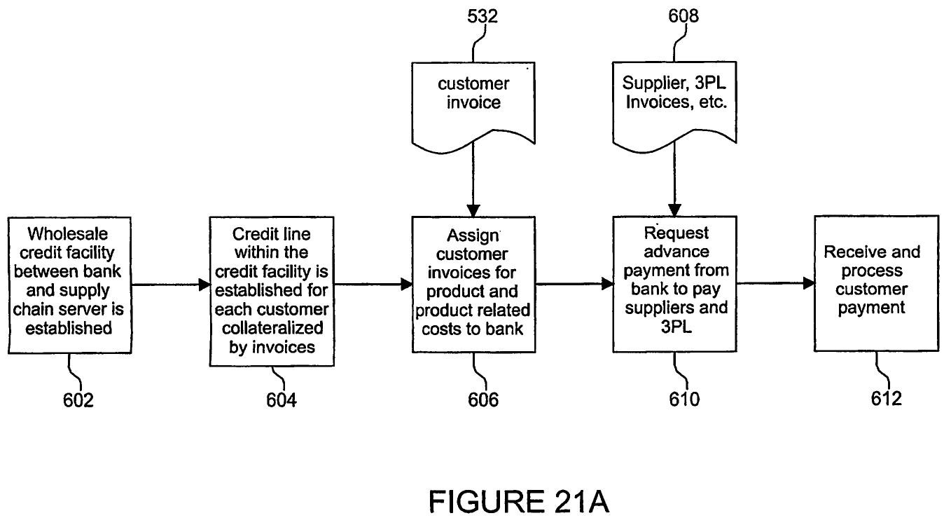

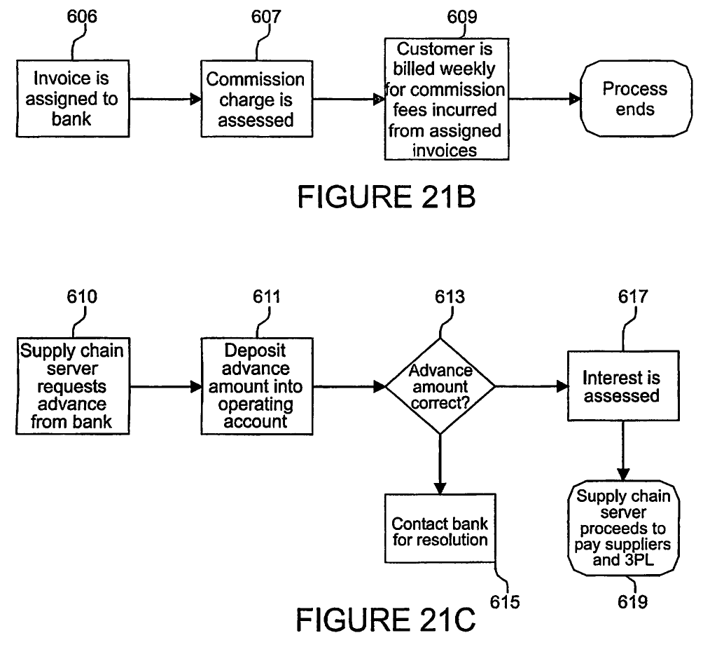

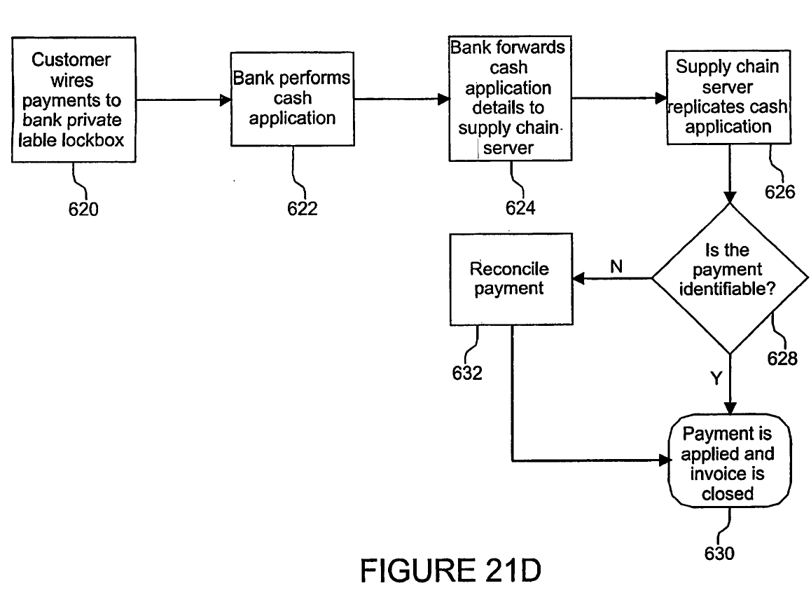

At step 386, supply chain server 74 pays suppliers 76 and 3PL 78 with a check and remittance advice note 388. If the financing option discussed below with reference to FIG. 21 is implemented, supply chain server 74 also sends an EFT file 390 to a bank 392. EFT file 390 is sent to suppliers 76 once a day and to 3PLs 78 once a month—based on freight tables. Some time thereafter, an account statement 394 is sent to supply chain server 74. Supply chain server 74 receives account statement 394 and compares 396 it with the EFT File 390 which was transmitted to bank 392. Then, supply chain server 74 generates 398 reports including month-end, quarter-end, etc. reports.

The Logistics Module is also used in situations where customer 72 desires to return materials obtained through supply chain network 70. Referring to FIG. 14, to initiate the return process, customer 72 makes a request 410 for authorization to return a part to supply chain server 74. Each supplier 76 provides supply chain server 74 with a pre-issued return authorization 412 for parts supplied by supplier 76. Supply chain server 74 receives request 410 and return authorization 412 and authorizes 414 the return of the materials using predetermined supplier-specific standards. Supply chain server 74 also uses a master supply record (not shown) to determine the source of the items to be returned. This master record shows which customers received products from corresponding suppliers and dates. In this way, supply chain server 74 can ascertain the origin of the product which the customer desires to return.

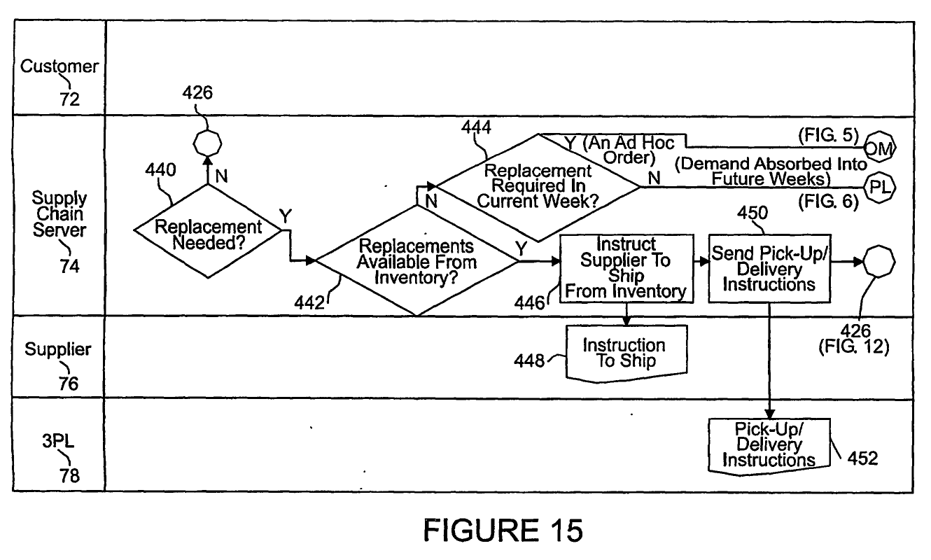

At step 416, supply chain server 74 sends 416 a return authorization 418 to both customer 72 and supplier 78. Supply chain server 74 then queries 420 whether the supplier, whose materials are to be returned, has an established return process. If the supplier does have such a process, that process will be used and supply chain server 74 sends 422 corresponding return instructions 424 to the customer 72. Control then branches to step 426 shown in FIG. 12. Otherwise, if the supplier does not have an established returns process, control branches to step 440 in FIG. 15.

Referring again to FIG. 12, at step 426, supply chain server 74 queries whether a returned product Proof of Delivery 430 has been received from the supplier's carrier 96 indicating that the product was returned to the customer. If not, supply chain server 74 waits a delay period 428 and then continues to look for receipt of returned product POD 430. Clearly, if the returned product POD is never received, then no credit will be issued. When supply chain server 74 receives returned product POD 430, it issues 432 a debit to supplier 76 which is applied when the appropriate payables are processed. Control then branches to step 364 as was explained in detail above.

Referring to FIG. 15, if the supplier does not have an established returns process, at step 440, supply chain server 74 determines 440 whether a replacement part is needed for customer 72. If no replacement part is needed, control branches to step 426 as was explained above with reference to FIG. 12. Otherwise, control branches to step 442 where supply chain server 74 determines whether replacement parts are available from any suppliers' inventory who has been listed as a customer's preference or which can provide immediate shipment. If parts are not available from inventory, control branches to step 444 where supply chain server 74 determines whether the replacement parts are required within the current week. If the parts are required within the current week, control branches for an ad hoc demand as was described with reference to FIG. 5. If the parts are not required within the current week, control branches to the Planning Module and the demand is absorbed into future weeks forecasts as, for example, described in FIG. 6.

Returning to step 442, if replacement parts are available from inventory, supply chain server 74 sends 446 instructions 448 to supplier 76. Instructions 448 direct supplier 76 to ship the available replacement parts from its inventory immediately. In such an event, supplier 76 is responsible for shipping costs and uses 3PL 78. Supply chain server 74 also produces 450 pick-up/delivery instructions 452 which are sent to 3PL 78. Control then branches again to step 426 described above with reference to FIG. 12.

Thus, by centralizing processes which were performed separately by suppliers, 3PLs, carriers and customers in the prior art, the Logistics Module enables transfer of products between suppliers and customers more efficiently than prior art supply chains. Moreover, problems in shipment and returns by customers are also handled more expediently and efficiently.

Fulfillment

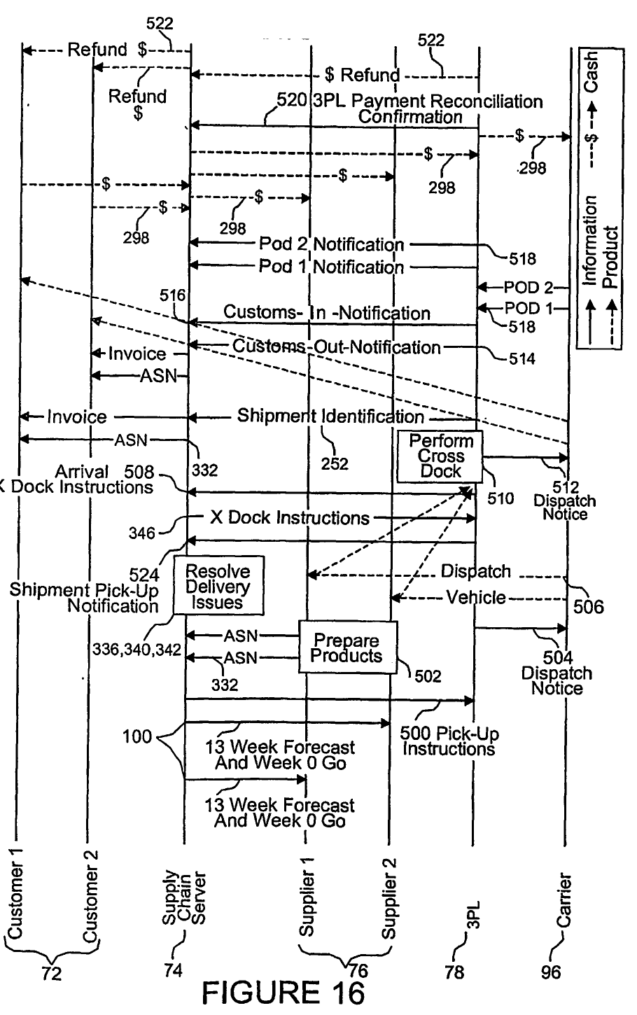

The Fulfillment portion of the Logistics Module is involved in ensuring the transportation of products from suppliers 76 to customers 72. Referring to FIG. 16, there is shown a time-phased Fulfillment process flow diagram in accordance with the invention. Much of the flow of information has already been described in detail with reference to the Planning, Order Management, and Logistics modules and so a detailed discussion of such information is omitted for the sake of brevity.

In the Fulfillment process, supply chain server 74 sends customer forecasts 200 and week 0 call-outs 202 (FIG. 4) to suppliers 76. Suppliers 76 send pick-up instructions 500 to 3PL 78 regarding the demanded products. Suppliers 76 then prepare 502 the products and send ASNs 332 (FIG. 11A) to supply chain server 74. Soon thereafter, 3PL 78 sends a dispatch notice 504 to carrier 96. Supply chain server 74 resolves delivery issues 336, 340, 342 (FIGS. 10A, 10B) while carrier 96 sends 506 dispatch vehicles to suppliers 76 to pick up the appropriate products. When the dispatch vehicles have obtained the products, a shipment pickup notification 524 is sent to supply chain server 74.

The dispatch vehicles travel to a designated cross-dock location (in this case, the 3PL is used as the cross-dock location though it should be clear that other locations could be used as is explained in more detail below) and await arrival of cross-dock instructions. Supply chain server 74 generates and sends 346 (FIG. 10E) cross-dock instructions 348 to 3PL 78. When the dispatch vehicles arrive at the cross-dock location, they send an arrival notification 508 to supply chain server 74. At this point, a cross-dock 510 is performed.

Unlike prior art supply chains, in supply chain network 70, the orders of a plurality of customers 72, who order the same or similar parts, are grouped together into larger orders to be procured from suppliers 76. Suppliers 76 then ship, through 3PL 78, a much smaller number of larger orders of these parts. In the prior art, suppliers 76 handled each order individually and shipped each order in an individual box. This was very costly because it required significant management of all the orders and parts for many customers.

In the present invention, supply chain server 74 instructs 3PL 78 to pick up the larger orders from suppliers 76, take the orders to the cross-dock point, and then un-pack and sub-ship the products to customers 72. The cross-dock point may be strategically located to maximize the efficiency of the shipment to the customers. At the cross-dock point itself, there is an automated inspection, acceptance, etc. of the arriving products. Errors in the shipment are typically fixed at the cross-dock 510.

With respect to the products themselves, the operator of supply chain server 74 takes title for customers 72 when the product leaves suppliers' 76 dock. Title is transferred to customer 72 when the product arrives with the customer. The operator of supply chain server 74 also acts as the importer of record.

Focusing again on FIG. 16, after cross-dock 510 has been performed at the cross-dock point (in this case at 3PL 78), a dispatch notice 512 is sent to carrier 96 requesting a pick up of the products and a shipment notification 262 (discussed below with reference to FIG. 17) is sent to supply chain server 74. The products are then picked up by carrier 96 and transported to the appropriate customers 72. Customers 72 may request a desired pickup or delivery location. While the products are being transported, supply chain server 74 sends ASN 332 (FIG. 11A) to customers 72. 3PL 78 may also send a customs in notification 514 and a customs out notification 516 to supply chain server 74 as appropriate. Such information would then be available to customers 72. After the products are dropped off with customers 72, carrier 96 sends a proof of delivery notification POD 518 to 3PL 78. 3PL 78 forwards POD 518 to supply chain server 74.

Thereafter, customers 72 send payment 298 (FIG. 24) to supply chain server 74 and supply chain server 74 forwards payment 298 (minus management fees) to suppliers 76, 3PL 78 and carrier 96. 3PL 78 then sends a payment reconciliation notification 520 to supply chain server 74. If any refund is necessary, 3PL 78 sends such a refund 522 to supply chain server 74. Supply chain server 74 then forwards refund 522 to customers 72.

Customers 72 using supply chain server 74 also have the ability to track the status of an order throughout the Logistics process. This order tracking capability may be offered to all the customers 72 using supply chain server 74 via an Extranet discussed below.

Thus, by providing suppliers with a smaller number of larger orders, and breaking down the larger orders at a cross-dock point, a less costly and more efficient Logistics process is available than in the prior art. Additionally, by having customers, suppliers, 3PLs, and carriers all report to a centralized supply chain server, all parties can receive current information concerning shipment processes. In one embodiment, such information is easily made available on a web site with information populated by the supply chain server.

Order Status

The present invention also provides customers with the ability to check the status of an order. A typical customer may be interested in knowing exactly what product the customer is getting and the delivery schedule particulars of the product. Listed below are some typical events that may be tracked by supply chain server 74 (FIG. 2). In each of these notifications, information may be sent to supply chain server 74 so that an extranet of supply chain server 74 (the hardware of supply chain server 74 is discussed more completely below) can be updated accordingly.

Order Release Notification

An order release notification provided by the Order Management Module 42 may be generated after a specific order is released to the supplier 76 or suppliers (one customer order may be fulfilled by several suppliers). This event may be used to inform customer 72 that their order has been reviewed and passed on to the suppliers who are responsible for fulfilling the order. The Order Management Module then updates the Extranet at the time of forecast or order release to the Suppliers.

Shipment Pick Tip Notification

A shipment pick up notification may be sent to supply chain server 74 by 3PL 78, indicating that a carrier has picked up a product from a given set of suppliers 76. This event provides supply chain server 74 with information used to monitor supplier 76 and 3PL 78 performance. This event also captures information that can be compared against the supply plan to identify discrepancies between expected and actual supplier shipments.

Cross-Dock Arrival Notification

A cross-dock arrival notification may be sent to supply chain server 74 by 3PL 78, indicating that a product has arrived at the cross-dock. This event also provides supply chain server 74 with information to continuously monitor 3PL performance.

Shipment Notification

A shipment notification may be sent to supply chain server 74 by 3PL 78, indicating that the order is on its way to customer 72.

Customs-In Notification

When applicable, a customs-in notification may be sent to supply chain server 74 by 3PL 78, indicating that a product is in customs.

Customs-Out Notification

When applicable, a customs-out notification can be sent to supply chain server 74 by 3PL 78, indicating that a product is out of customs.

Proof of Delivery (POD) Notification

A POD and final notification can be sent to supply chain server 74 by 3PL 78, indicating that a customer shipment has been delivered to the specified locations.

Flow Monitoring

Server 74 can monitor the flow of products through a bottleneck or pinch point in the supply chain. For example, it may be difficult to book a flight to a particular destination or to make it through customs at a particular city. A notification may be sent any time parts are bumped from a flight or when the parts make a crowded flight. A notification can be sent to a supplier's production line as well.

Billing and Payment

Once customer demand is fulfilled, the Billing and Payment Module 48 is responsible for defining the rules and activities used in performing financial transactions such as billing and processing of customer payments. An additional offering of the Billing and Payment Module is to enable the supply chain network's customers to view the status of pending orders and track the status of an order up until the time the customers receive their product.

Referring generally to FIG. 17, after customer demand is fulfilled and a shipment notification 262 from 3PL 78 is received 260, supply chain server 74 triggers the generation of a sales order 290. At the same time, the shipment notifications are reviewed to determine any deviations between expected and actual customer shipments. This process helps to identify any short shipments or damage done to products either in transit or at the 3PL facility, and involves attending to any discrepancies in part numbers, quantities, and prices, for example.

In addition, customer may receive several shipments from suppliers via supply chain network 70 on a given day. Customers preferably receive one invoice per day that consolidates those shipments into a single bill. All financial transactions between supply chain server 74 and customers 72 can, in a preferred embodiment, be performed by using EFT (Electronic Funds Transfer), thereby further reducing overall cycle time.

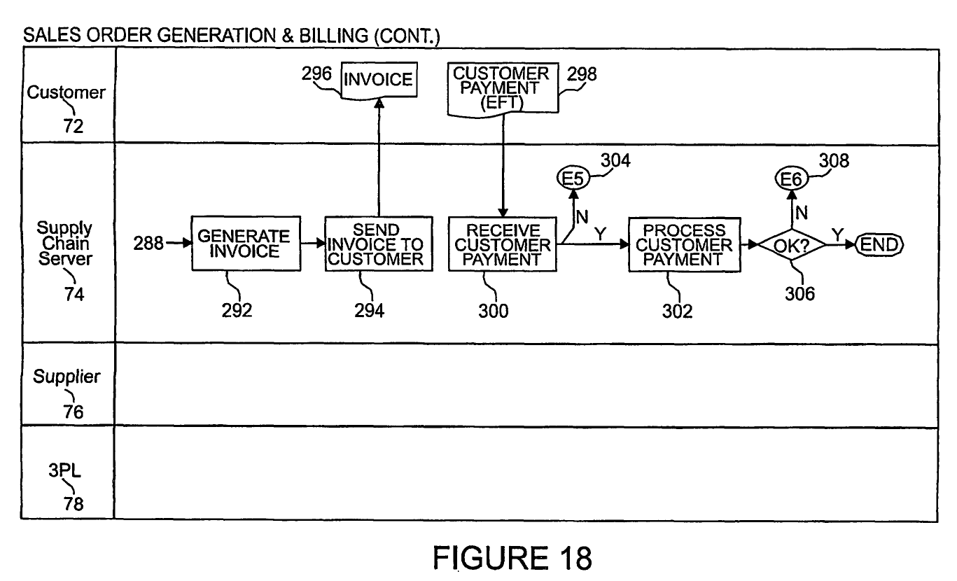

Referring now to FIGS. 17 and 18, the Billing and Payment Module 48 (FIG. 3) begins generally with supply chain server 74 receiving 260 a shipment notification 262 from 3PL 78 indicating that the products have been delivered to customer 72. The receipt 260 may be through an EDI. Supply chain server 74 validates 264 shipment notification 262 and calculates 266 the order pricing of the shipment. In validation 264, supply chain server 74 compares the total quantity in shipment notification 262 with a quantity specified in supply plan 338 (see FIG. 10E). The comparison could include more than one shipment notification per customer part number, and should take into consideration pre-defined tolerances. If supply chain server 74 determines 270 that the shipment notification is valid, validation 264 ends. Otherwise, an error routine 272 is performed as was explained above with reference to FIG. 11B for error routine 342. If an error did occur, a data integrity issue (shipment notification accuracy) is indicated, or a 3PL performance issue (material lost or damaged at 3PL facility or in transit) may exist. In any event, Planner intervention is used to implement both short and over shipment resolutions in error routine 272.

In calculate order pricing circuit 266, the price of the order associated with shipment notification 262 is calculated based upon cross-dock instructions 346 (FIG. 16), a contract 276 between the supplier 76 and customer 72, and the actual product 278 that was shipped. This cost is based on the number of components purchased and prices negotiated with supplier 76. Additional costs are added for services not included in the basic management fee. These could include, for example, expedited delivery, special labeling or packaging, etc. In addition, an ad hoc order may be given an additional charge.

In addition to the charges for the products themselves, supply chain server 74 also calculates 280 the freight charges associated with shipping the products based upon a freight table 282 having standard freight charges. In general, freight charge is based upon weight, number of pieces in the shipment, and the freight type (e.g., a pallet, package, etc.). A reconciliation may be used periodically to make adjustments to the customer's accounts based upon reconciliation by 3PL 78. Some prior art techniques generated sales orders too soon and so freight charges needed to be applied after the sales order. As can be discerned, such a problem is not present in the architecture of the present invention.

Then supply chain server 74 calculates 284 the sales order total using applicable rate tables 286. These tables are used to calculate customs duties and foreign currency exchange rates. Insurance charges are added, as well as value added taxes and sales taxes. Supply chain server 74 then generates 288 a sales order 290. In a preferred embodiment, a single sales order is generated per customer part number and the charges are itemized; for example, freight, taxes, additional services, etc.

Referring now also to FIG. 18, supply chain server 74 then proceeds to steps 292 and 294 where it generates 292 and sends 294 an invoice 296 for sales order 290 to customer 72. Invoice generation is performed automatically for each order using electronic invoice outlining terms for each sales order. Payment terms are based on the shipment date and include itemized charges as referenced above. Invoice financing also can be provided, which involves additional fees such as commissions and finance charges, as outlined below. All invoices going to the same customer should be consolidated each day, so that the customer will receive one invoice per day. Sending the invoice 294 thus creates a receivable.

At some point thereafter, customer 72 sends payment 298, preferably through an electronic funds transfer (EFT). Payment is received at 300. Preferably, payments are received by a third party finance institution, such as a bank, particularly in connection with invoice financing arrangements as described further below, in which case supply chain server receives a notice from the finance institution. If payment 298 is not received within a contractually defined period of time, an error routine 304 is performed where supply chain server 74 contacts either the customer or the corresponding bank.

If payment 298 or payment notice is received within the defined period of time, payment 298 is processed 302 by the supply chain server so that incoming payments are matched with open invoices. A plurality of suppliers and 3PLs may have been involved in providing parts for the customer. Accordingly, payment 298 may need to be broken up and distributed, preferably by way of instruction to the finance institution or bank, which then sends payments to the appropriate suppliers and 3PLs. In addition, the customer's account is reviewed for any other outstanding invoices (credit or debit balances) and payment is applied to that customer's account accordingly. Regular account reconciliations with third parties are undertaken.

At step 306, supply chain server 74 determines whether customer 72 made a full payment or overpaid for a given invoice 296. If there was no problem with the payment, the invoice routine ends. Otherwise, error routine 308 is implemented in which either a collection process is initiated based on the customer's past history or a credit is applied to the customer's account in the event of an overpayment.

Thus, the present invention provides centralized control of supply chain network 70 in supply chain server 74 and allows suppliers to avoid the costs incurred in managing billing processes with customers.

Financing

The structure of supply chain network 70 also enables (but does not require) the possibility of providing new forms of financing for customers procuring products. As stated above, in prior art forms of financing, a supplier gave a customer a payment term which was frequently ignored by the customer. Suppliers would therefore increase the prices of products (de facto interest) to compensate for prospective losses due to buyers not paying on time. Sellers were also at the mercy of unreasonable prices from distributors when sellers wished to sell products early to improve their balance sheets.

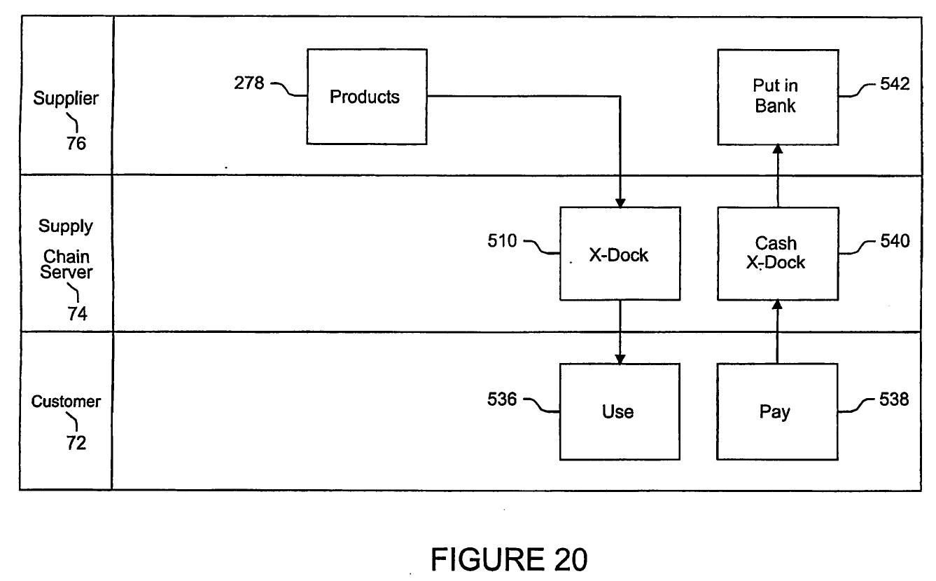

The invention, in providing a three party architecture (instead of just the supplier and customer of the prior art) removes the de facto interest and the prior art distributor. Referring first to FIG. 20, there is shown one example of the flow of title and payment in supply chain network 70. As stated above in the description of the Logistics Module, the operator of supply chain server 74 takes title of products 278 once the products leave supplier 76. Products travel to cross-dock 510 and then to customer 72. Customer 72 uses the products 536 and sends payment 538 to supply chain server 74 (e.g., at the cross-dock point). Supply chain server 74 receives payment 540 and sends it to supplier 76. Supplier 76 receives the payment and deposits the payment 542 in the supplier's bank.

An alternative form of financing is shown in the general overview of FIG. 21. As with the flow shown in FIG. 20, products 278 are sent to cross-dock 510. At that time, a copy of the customer invoice 532 is sent to a financier or bank 392 as collateral for payment of the customer's invoice. Bank 392 procures the necessary financing 534 and provides it to supply chain server 74 at 540. (In a pay-upon-pay alternative, the supply chain server may also fill the role of financier.) Supply chain server 74 then forwards financing 534 to supplier 76 who then deposits 542 financing 534 in the supplier's bank.

Referring to FIG. 21A, a process schematic shows a preferred set of arrangements for providing the financing 534 described above for those customers electing to participate in invoice financing. Invoice financing is available to customers whose suppliers and 3PLs require payment in shorter terms than the payment terms that would exist between the supply chain server 74 and the customer.

Initially, a wholesale credit facility 602 is established between bank 392 and the supply chain server 74. This credit facility provides the basis for a master account that is available to both the bank and the supply chain server. A credit line 604 is established within the credit facility 602 for each customer. The credit line is collateralized by invoices. As each customer is approved to participate in the invoice financing structure, a specific sub-ledger account and a credit limit are established for that customer.

When a customer purchases product through the supply chain server, a customer invoice 532 is generated, as noted above. The customer invoice 532 is assigned 606 to the bank 392 through the supply chain server 74. Preferably, invoice assignment takes place on a regular basis, for example, daily or weekly, depending on volume. Invoices are aggregated and submitted to the bank with a top sheet attached outlining the contents of the aggregated package.

Referring to FIG. 21B, once the invoice is assigned, a commission charge is assessed 607. Customers are billed weekly 609 for commission fees incurred from assigned invoices. Commission charges generally are set fees charged per invoice to customers for administration of the invoice-financing program. The commission charges cover collecting and applying payments to customer accounts, and assessing and approving customer credit. Commission fees preferably are collected by the bank and are apportioned by agreement between the supply chain server and the bank.

Periodically, or as third party invoices 608 (FIG. 21A) are received from suppliers 76, for example, supply chain server 74 determines the accuracy of the invoices and requests advance payment 610 from finance company 392 in order to pay the suppliers. Similarly, payments to 3PL handlers, customs agents, etc. also are invoiced and paid according to contractual terms. More specifically, referring to FIG. 21C, the advance amount is deposited to the supply chain server's operating account 611. If the amount advanced is incorrect 613, the bank is contacted 615. If the advance amount is correct, interest is assessed 617 and the supply chain server proceeds to pay only suppliers and 3PLs from the advance to the operating account 619.

Other safeguards can be built in, such as limiting the amount of the advance so as not to exceed the specific customer's credit line or a percentage of a collateral pool. Similarly, if a customer has been slow to pay, approval of advances can be withheld. At each step, the amounts provided can be checked by way of error routines and protocols can be established for addressing and resolving any errors.

Once customer payment 538 is received, it is processed and applied against advances 612. Preferably, payment is made to a private label lockbox 620 (FIG. 21D) in accordance with contractual terms. Monthly statements on the master account are provided. The master account and individual sub-ledger accounts are available for viewing by the supply chain server over an extranet, for example. Individual customers can be provided with extranet views of their sub-ledger accounts, as well.

Referring again to FIG. 21, supplier 76, therefore, gets paid soon after products 278 are shipped, and generally before supply chain server gets paid. Accordingly, bank 392 effectively loans customer 72 the financing needed to pay supplier 76 and supply chain server 74 secures this obligation of customer 72. Customer 72 continues to use 536 products 278 and then produces payment 538 which is now sent directly to bank 392. Bank 392 deposits 544 payment 538, sends 546 invoice 532 back to customer 72 marked as paid and sends a notification 548 to supply chain server 74 indicating that invoice 532 was paid.

More specifically, customer 72 wires payments to a private lockbox 620 at the bank as shown in FIG. 21D. The bank applies the cash to any advances 622, and forwards cash application details to the supply chain server 624. The supply chain server replicates the cash application 626. If the payment can be properly identified 628, payment is applied and the invoice is closed 630. Otherwise, the payment discrepancy is reconciled 632. Preferably, all funds for payment will be received only by electronic transfer.

In this way, once product 278 is delivered, customer 72 still has a payable on its records, even though supply chain server 74 is securing an obligation on the customer's behalf. The payable itself is actually to supply chain server 74 or bank 342 and not to supplier 76. Such a payment schedule is extended to customers with exemplary credit. Further, if the customer does not pay on time, supply chain server 74 has the option to hold back on the flow of parts to customer 72 thereby causing customer 72 great expenses. Supplier 76 benefits in that it receives an earlier and regular payment. As supply chain server 74 pays suppliers 76 on time, suppliers 76 no longer need to charge de facto interest. This cost savings is passed to customer 72 and realized as profit for the operator of supply chain server 74.

When suppliers 76 desire to ship products 278 before a time necessary to satisfy customers 72, supply chain server 74 can safely retain some of these products based upon customer forecasts 200 and charge a lower interest rate to suppliers 76 than that charged by distributors of the prior art.

Using the above described techniques, supply chain server 74 can arrange payment term financing in order to leverage more favorable pricing or to create a more appealing balance sheet for the parties involved. For example, as suppliers can be paid sooner than in prior art supply chains, suppliers are more willing to allow for price concessions and lower financing costs. Supply chain server 74 can arrange financing that permits inventory to be taken off balance sheets and off premises.

Supply chain server 74 can also shift the risks in changes in commodity pricing to more risk inclined parties. For example, in volatile commodities (e.g., Dynamic Random Access Memories—DRAMs), by controlling the flow of products and cash, server 74 can also provide risk shifting products such as hedges, calls, puts, etc. Prior art supply chains could not provide such products because there was not a single party who controlled products and cash.

Server 74 can also provide insurance that was not available in the prior art. As server 74 is connected with multiple customers and suppliers, server 74 can plan for volatile swings in demand or supply of products. For example, server 74 can receive extra products from suppliers and retain these products in case customers experience an unforeseen increase in demand. The extra products received by server 74 are determined by actuarial calculations based upon prior forecasts. These extra products are updated periodically so that they remain fresh and not outdated. In this way, server 74 insures for demand spikes and supply shortages.

Thus, the provision of supply chain server 74 enables the parties of the supply chain network to use financing options not available in the prior art. Additionally, suppliers can provide products more cheaply because de facto interest is no longer necessary.

Network and Information Management Services

Overview:

Supply chain server 74 occupies a central position in a many-to-many relationship between the members of the supply chain. Consequently, the server can perform many of the functions of supply base management, operations management, and infrastructure management. Significantly, while managing various aspects of the central supply position, server 74 accumulates valuable data that can be analyzed and provided in useful forms to the supply chain network participants and others to help them better manage their operations. In a preferred embodiment, the information delivery capability is implemented primarily by a secure Extranet site. Network management services and information delivery provided by the supply chain server are very useful to a supply chain network's business model, as an efficient supply chain network incorporates both accessibility to, and visibility of, real-time information.

The supply chain server sets up and operates several network management services, thus relieving members of the supply chain, particularly customers, of the need to perform these tasks. Network management services provided by the supply chain server can be categorized generally in the following areas: supply base management, operations management, and infrastructure management. Supply base management includes negotiating prices, terms, and conditions with suppliers; quoting; sourcing; evaluating supplier performance; and customer commodity management support. Operations management includes customer forecast analysis, chronic shortage analysis, market monitoring and allocation, issue resolution, and performance measurement. Infrastructure management includes implementation and support of master data files, extranet communications, technology interfaces, global/international trade compliance, and logistics.

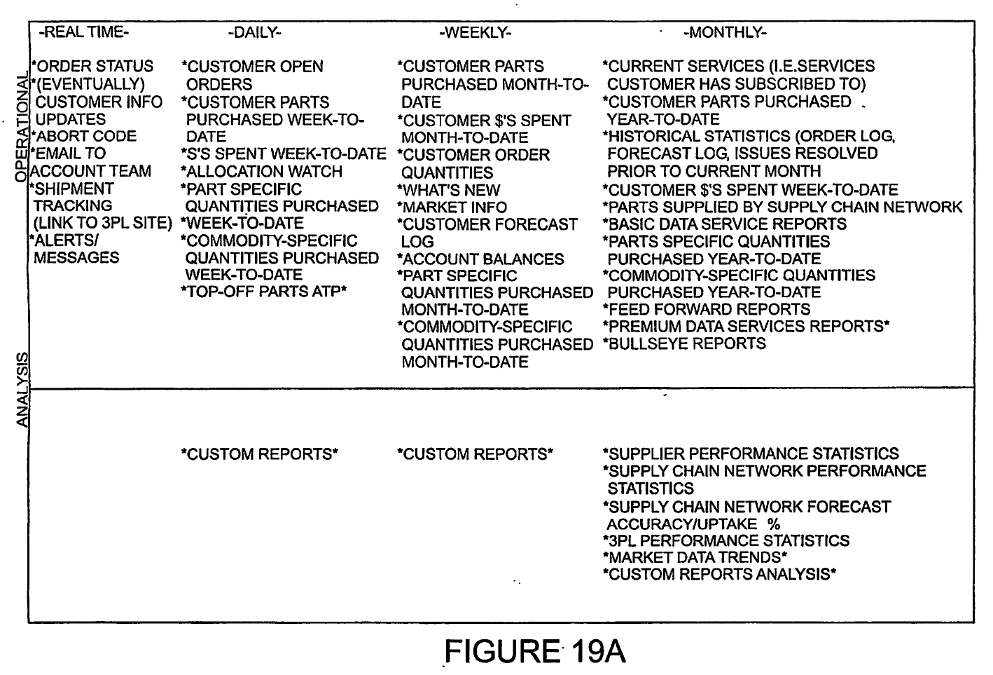

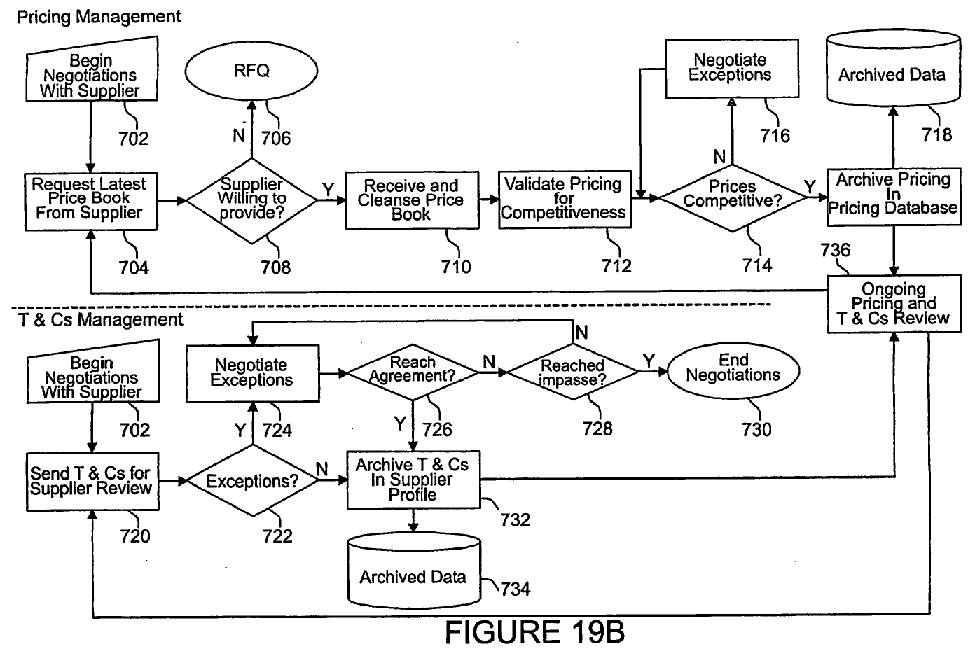

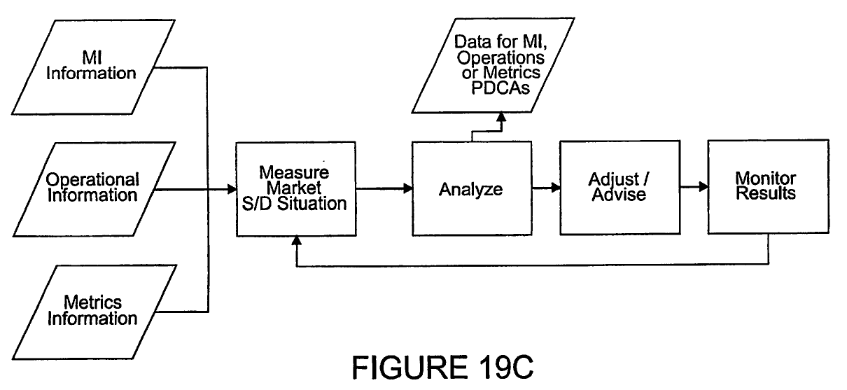

Information delivery, rather than being a discrete process that happens periodically, is a capability that enables an essentially continuous communication of information between supply chain server 74 and its business partners, (e.g., 24 hours-a-day, 7 days-a-week). In addition, the information delivery capability provides the means for customers (and potentially suppliers and 3PLs) to initiate workflow processes. For example, although the process for the customer's ability to abort an order is located in the Planning Module, information delivery will handle the communication of the abort code (e.g., a button on the Extranet that triggers an email or EDI message to initiate the work flow). FIG. 19A shows some information which can be provided to users of supply chain network 70. The information delivery process allows information to be delivered in a very timely manner, according to the needs of the supply chain network participants.

As can be discerned, the type of information available to Customers, Suppliers and the 3PL includes order-specific and forecast information/statistics and customer-specific statistics (e.g. Week-to-date, Month-to-date, Year-to-date, etc.), and comparisons with industry forecasts and pricing. The following are examples of preferred network management services provided by the supply chain server and generating information to be supplied to members of the supply chain.

Pricing, Terms, and Conditions Management:

As part of supply base management, supply chain server negotiates and maintains information on product prices, and terms and conditions (T&Cs), with suppliers. The supply chain server negotiates for prices and T&Cs that are competitive. These are reviewed to ensure that favorable prices and terms are being provided to customers.

FIG. 19B provides a process schematic related to negotiation of prices, terms, and conditions, and storage of related information. Referring to the upper half of FIG. 19B, pricing management is initiated at step 702 when negotiations begin with the suppliers and the latest price book is requested 704. A request for quote (RFQ) 706 issues if the supplier is unwilling to provide a price book 708, otherwise the price book is obtained and cleansed of items 710 that will not be managed by the supply network. The price book is provided in an acceptable format, such as an industry standard spread sheet or database, for example. The supply chain server validates pricing for competitiveness 712, and if prices are not competitive 714, exceptions are negotiated 716. More specifically, a commodity manager evaluates pricing through comparisons with pricing databases generated and maintained by the server, and other market relevant information. Competitive pricing is stored 716 in a data archive 718.

Stored pricing information will include the supplier name, the supplier part number, current pricing, unit of measure, minimum pack quantity (MPQ), minimum order quantity (MOQ), lead time (weeks), valid pricing period, time flag to indicated when pricing expires, and volume for which pricing is valid. Accommodations for prices in foreign denominations can be made as required.

A parallel process takes place regarding terms and conditions, as shown in the lower half of FIG. 19B. Once the negotiation is initiated 702, the supply chain server's terms and conditions are sent to the supplier for review 720. Exceptions are identified 722 and negotiated 724. If agreement cannot be reached 726 on the exceptions, and impasse is reached 728, negotiations will end 730. Otherwise, acceptable terms and conditions are stored 732 as part of a supplier profile in a data archive 734. Prices, terms, and conditions are subject to ongoing review 736.

Accumulated pricing data is used for price tracking purposes, hence a database is established and maintained in which prices are archived. In addition, a transaction report is generated which tracks supplier shipment history. The transaction report is reviewed for trends in shipping history that could provide leverage for better pricing and T&Cs.

Manage Market Supply/Demand Situation

FIG. 19C is a schematic illustrating a management system for market supply and demand. The process monitors the supply/demand situation, as well as general market behavior, for parts and commodities that are managed by the supply network. Based on the analysis, customers and suppliers are advised of the supply/demand situation, and adjustments are made in network operations.

The process will utilize aggregated customer forecast data, component prices (by customer), inventory tracking data, inventory data from suppliers and customers (based on availability), industry standard lead-times, spot buy prices, supplier capacities, and other market intelligence activities.

The process is executed on an on-going basis, preferably being run on a bi-weekly basis, to focus on month end and quarter end periods. As part of the process, out-liers will be identified and monitored, and “sanity” checks will be performed. Communications with customers/suppliers will take place, and internal operations adjustments will be made as needed.

Various market measurements can be established. Each measurement includes a definition, an equation, a target (if applicable), and a tolerance. Tolerance ranges could be set for lead time changes, customer group inventory trends, customer group demand trends, customer group forecast demand variance (week to week), and customer group forecast demand versus industry forecasted demand.

Industry reports on customer group inventory and demand include customer group, industry segment, geography, commodity, supplier part number, aggregated inventory level, aggregated demand by period, industry projections of customer demand, industry projections of inventory levels, delta (actual/percent) between customer group inventory and industry inventory for each period, and delta (actual/percent) between customer group demand and industry demand for each period.

In order to provide comparisons, the industry and the customer group actually will be represented by trend data points. The report will have selectable parameters for hierarchy level, product hierarchy, geographic regions, and size of deltas. The report will identify areas where the customer groups ordering and inventory patterns are aberrant from the rest of the industry, and the direction of the industry as a whole (loosening or tightening.)

Other reports generated by the network include lead time analysis, outlier demand reports, spot buy price report, and supplier capacity analysis reports. Each of the reports is accessible by customer hierarchy, product hierarchy, geographic hierarchy, and industry segment. The reports will provide inventory on demand and inventory trends, and outlier can be identified. Based on these reports, planning personnel first can try to identify root causes of the situation, based on day-to-day tactical events. If necessary, supplier management can support planning personnel in determining underlying causes. Market intelligence can be used when additional information and perspectives are needed.

Once root causes are identified, the network server can implement the action plan determined to be necessary to address the problem. If the issue is customer or supplier related, account management will work with customer or supplier management to determine the next steps. Various actions that can be taken include flipping to an “on allocation” mode for a certain parts, group of parts, or supplier. As a result, the server will issue hard POs instead of the order-to-forecast operation. Also, orders can be placed with longer lead times, and forecast and order quantities can be increased or decreased to hedge or not hedge as necessary. Relevant reports can be sold to support the data presented.

Thus, the relationship between customers, suppliers, and the network can be determined, appropriate actions can be taken, and changes can be implemented to improve network performance, as well as the performance of suppliers and customers in the network.

Forecast Rationalization

Current demand, existing sales orders, forecast history, and shipment history is compared in order to assist planner in managing the planning process and to communicate to customers their overall forecast accuracy to order percentage.

The network server takes each weekly forecast and compares it to historical usage in order to identify forecast accuracy. Historical forecast data is used to determine whether customer forecasts accuracy is improving, and to identify inconsistencies in ordering and forecasting.

Chronic Shortage Management

Chronic shortages can be identified and monitored by the supply chain server. The objective is to improve the customer fill rate and continuity of supply. Monitoring is carried out and shortage resolution plans are developed on a regular basis.

The server planning group runs chronic shortage processes each month. Shortages are defined as any quantity that was requested, but was not shipped by the original customer request date. The process identifies chronic shortages by running a report in the PTB and filtering the report on a predefined definition. Chronic shortages are those that reoccur fifty percent of the time over a thirteen week period, with an average fill rate of 95% or less. Pareto analysis is completed based on shortage codes and grouped by customer, supplier, and server or market condition related issues. Once the root cause is identified, the information is used to recommend and execute a resolution plan. An historic archive is maintained to assist in the resolution of future chronic shortage problems, so that previous action plans and trends can be analyzed.

Various actions that can be taken depending on whether the root cause is supplier or customer based. Supplier based solutions include changing the priority of suppliers on existing vendors, recommending an alternative part that meets customer design specifications, recommending new supplier and part for customer, and negotiating changes in supplier terms and conditions under the contract. Customer based solutions include providing information on chronic shortage problems to help drive internal changes, and reviewing supplier options and better align customer with supplier profile.

Architecture

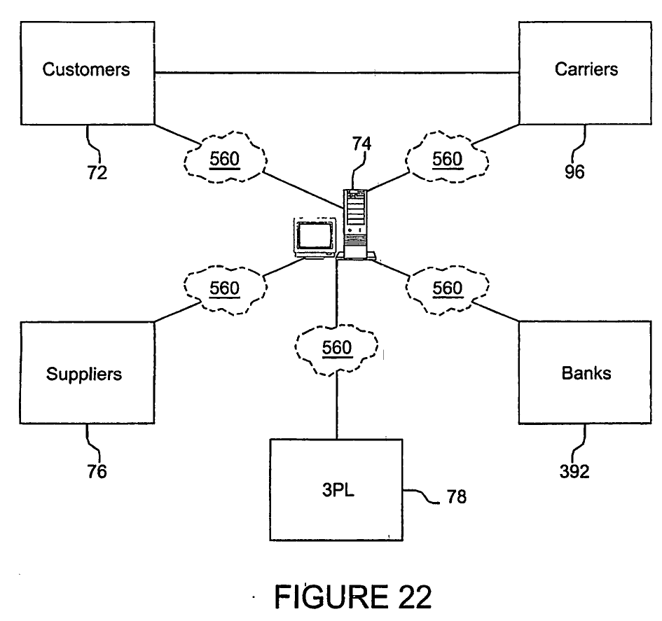

Supply chain network 70 can be set up in many ways. A general architectural set up is shown in FIG. 22. Supply chain server 74 is shown coupled to all of customers 72, suppliers 74, 3PL 78, banks 392 and carriers 76. This connection could be through, for example, a network 560 such as the Internet.

If network 560 is used, the, communication among the parties shown in FIG. 22 could be through any know arrangement for accessing a communication server, such as dial-up serial line interface protocol/point to point protocol (“SLIP/PPP”), an Integrated Services Digital Server (“ISDN”), a dedicated leased-line service, broad band (cable) access, a Digital Subscriber Line (“DSL”), asynchronous transfer mode (“ATM”) or other access techniques. If supply chain server 74 is used to host a web page that is accessed by one of the parties of FIG. 22, supply chain server 74 should be able to provide web page HTML and/or Java data. Supply chain server 74 is not limited to such hardware requirements.

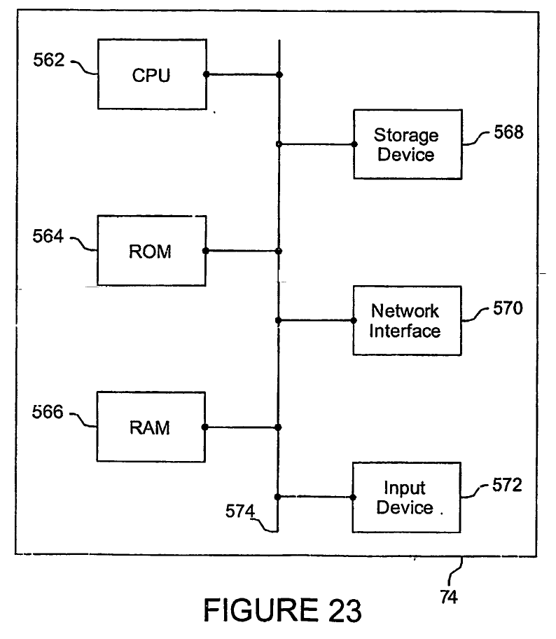

Supply chain server 74 itself can be implemented using many known hardware structures. In its most general sense, supply chain server 74 can be implemented using a structure like that shown in FIG. 23. A CPU 562 is coupled to a ROM 564, a RAM 566, a storage device 568, a server device 570 and an input device 572 through a bus 574. Again, supply chain server 74 is not limited to these structures.

Referring to FIG. 24, there is shown a more detailed architecture of supply chain server 74. Supply chain server 74 includes an extranet manager 580, an ERP system 584, a planner support tool 586, and a messaging services section 588 all coupled to a system monitor 582. System monitor 582 monitors the operation of all the components of server 74 and facilitates the flow of information among these components. As shown in FIG. 24, customers 72 and suppliers 74 can communicate with extranet manager 580 through a firewall 590. Customers 72, suppliers 74, 3PLs 78 and banks 392 all communicate with messaging services section 588 of supply chain server 74 also through firewall 590.

Extranet manager 580 provides customers 72 and suppliers 74 with access to order and forecast information, access to any premium information services contracted with supply chain server 74, and access to Customer Master Data which is bibliographic information (e.g. name, address, account number, etc.) of customers. Extranet manager 580 performs this function by displaying web pages and generating new web pages with information received from ERP system 584 discussed below. Finally, Extranet manager 580 manages site membership and security and provides secure communication of data to and from server 74.

ERP (enterprise resources planning) system 584 provides server 74 with applications and systems support for financial, order management, demand management, procurement, and other enterprise processing capabilities. ERP system 584 allows for incorporation of data from suppliers 74, customers 72, logistics providers 78 and financial institutions 392 (“partners”) and stores and manages the data from these partners in a standard format. ERP system 584 also provides employees of server 74 with real time access to enterprise information and provides workflow capabilities to ensure completion of business processes. Finally, ERP system 584 keeps track of the Customer Master Data.

Messaging services section 588 streamlines communications between supply chain server 74 and all of its partners. Messaging services section 588 translates all received information into a standardized format which is input into ERP system 584. Conversely, messaging services section 588 also receives information from ERP system 584 and generates outgoing messages in the format expected by a particular partner. Messaging services section 588 manages secure data transmission between server 74 and its partners, allows use of the Internet for all transmissions, and provides logging and serialization of all transmissions for audit purposes.

Planner support tool 586 allows Planners working for server 74 to manipulate forecast, demand and supply data. Planner support tool 586 aggregates data extracted from ERP system 584 thereby facilitating flexible, configurable analysis methods, providing a wide range of reporting capabilities, providing a definition of exception conditions in the analysis process, providing courses of action (workflow) should an exception occur, providing secure access to data, and allowing for multiple user access to this data while preserving the integrity of the data. By providing a Planner Support Tool that is external to Extranet 580, which works with ERP system 584, and which is coupled to messaging services station 588, a desirable supply-demand balance can be achieved.

### SUMMARY

A supply chain server handles many of the processes previously performed by individual entities of the prior art in a more efficient and cost minimizing architecture. By consolidating purchases and supply chain management, the supply chain server eliminates many of the steps and costs expended by customers and suppliers of prior art supply chains. Customers benefit through lower prices; lower expenses for freight, buying, and planning systems, etc.; faster and more reliable deliveries; shorter lead times and lower inventories; supply chain management savings; lower duties and taxes; increased product expertise; complete supply chain visibility; improved data integrity; improved profits; improved service to their customers; improved suppliers; and improved decision making. Suppliers benefit by way of lower selling expenses, lower planning costs, lower inventories, improved delivery, lower product costs, visibility of demand, lower operating expenses, and reduced manufacturing costs from smoother production flows. This all leads to improved profitability while selling at lower prices which, in turn, will increase demand.

Both customers and suppliers may have access to a secure web site hosted by supply chain server which will provide valuable information that was not available in the prior art. This information includes customer buying habits, and the size and growth rates of markets served.

The costs of supply chain server will be borne by customers based upon the number of part numbers and the cumulative value of purchases. Suppliers need not be charged a fee so that the lowest possible price may be provided by suppliers. As the supply chain network is procuring products in bulk, it will receive a lower cost for the items and will realize this lower cost in profits.

Although demand and supply of products have been discussed, it should be clear that demand and supply of any resource, including services, is also within the scope of the invention. The term “product” throughout the specification thus refers to any such resource or service. For example, customers could be individuals desiring bandwidth on a trunk line in a network. Suppliers would then be sources of network bandwidth. Customers could also be, for example, individuals desiring airplane tickets or theater seats from corresponding suppliers.

Although the present invention has been described in relation to particular embodiments thereof, many other variations and modifications and other uses will become apparent to those skilled in the art. Therefore, the present invention is not to be limited by the specific disclosure herein.

1. A networked system for managing supply base operations for a plurality of suppliers and a plurality of customers, said networked system comprising:
an order planning module, wherein said order planning module receives at least one forecast of a plurality of demanded items from at least one customer of said plurality of customers, and locates at least one supplier of said plurality of suppliers for said at least one forecast in said network;
an order management module, wherein said order management module controls processes associated with distributing at least one item of said plurality of demanded items from said at least one supplier to said at least one customer;
a logistics module, wherein said logistics module monitors reception of at least one item from said at least one supplier and monitors delivery of said at least one item to said at least one customer; and
a financial module, wherein said financial module provides for billing and payment of said at least one demanded item.

2. The system of claim 1, wherein said at least one forecast of said plurality of demanded items received by said order planning module from said at least one customer provides for thirteen weeks of future demands.

3. The system of claim 1, said order planning module further determines whether said at least one forecast complies with existing contractual obligations between said at least one customer and said at least one supplier.

4. The system of claim 3, said order planning module further generates an alert when said at least one forecast does not comply with said contractual obligations.

5. The system of claim 1, said order planning module further determines whether said at least one forecast contains errors.

6. The system of claim 5, wherein said errors include at least one of an inaccurate part number, an incorrect cross reference, an added part, a dropped part, an expired part, a part to be expired, and an invalid part number.

7. The system of claim 1, wherein said order planning module receives forecasted demands from said at least one customer for an item, converts said forecasted demands to represent supplier part numbers, delays processing said demands until said order planning module collects customer information, said customer information including customer contract information and customer product information, and, after determining said demand is valid with said customer contract information and said customer product information, forwards said forecasted demands to said plurality of suppliers.

8. The system of claim 7, wherein said at least one supplier transmits capacity exception information to said order planning module, said capacity exception information representing supply shortfalls in at least one week prior to a current week.

9. The system of claim 8, wherein said forecasted demands are validated in response to said capacity exception information.

10. The system of claim 1, wherein said order planning module further receives an ad hoc demand for an item from said at least one customer, converts said ad hoc demand to represent supplier part numbers, delays processing said demand until said order planning module collects customer information, said customer information including customer contract information and customer product information, and after determining said demand is valid with said customer contract information and said customer product information with said demand, forwards said ad hoc demand to said at least one supplier.

11. The system of claim 1, wherein said order planning module, said order management module, said logistics module, and said financial module interact, to create a supplier purchase order, said supplier purchase order based on an advanced shipping notice comprising:
a receipt and cross-dock instructions for third-party logistic operators;
delay processing said supplier purchase order until requests for said demanded items are received and processed; and
generate a sales order and match said receipt with said sales order and a supply plan received from said at least one supplier.

12. The system of claim 11, wherein said cross-dock instructions include at least one programming, assembly, aggregation, pickup, delivery instructions and customer return instructions.

13. The system of claim 1, wherein said logistics module further performs reverse logistics, said reverse logistics including controlling processes to move said demanded items from a predetermined location to capture value and disposing of said demanded items.

14. The system of claim 1, wherein said at least one supplier generates an advance shipping notice, said advance shipping notice representing at least one of an item shortage, cross dock instructions, a demanded item description, and transmits said advanced shipping notice to said supply chain server said supply chain server cross references said advanced shipping notice with a previously received supply plan from said at least one supplier, and creates a purchase order when said advanced shipping notice is cross-referenced.

15. The system of claim 1, wherein said at least one forecast is formatted as at least one of e-mail, XML, and EDI.

16. The system of claim 1, wherein said order planning module further receives information directed to contractual agreements between said plurality of customers and said plurality of suppliers, and receives at least one request for at least one of items and services from said at least one customer, and determines whether said at least one request is included in said contractual agreements.

17. The system of claim 16, wherein said services include at least one of expediting deliveries, providing special labeling, and providing special packaging.

18. The system of claim 1, wherein said order planning module further receives said forecasted demands from said customers and supply commitments from said suppliers, validates at least one of said forecasted demands and said supply commitments, and allocates available supply to fulfill said forecasted demands.

19. The system of claim 18, wherein said supply commitments represent items available from said supplier to fulfill said forecasted demands.

20. The system of claim 18, wherein said order planning module further allocates available supply according to predefined rules when said supply commitment reveals said available supply cannot fulfill said forecasted demands.

21. The system of claim 20, wherein said available supply includes items that are previously identified as available to promise.

22. The system of claim 1, wherein said order planning module further receives said forecasted demands from said at east one customer, receives a supply commitment from said plurality of suppliers, and generates sales order commitments based upon said forecasted demands and an order history of each of said at least one customer.

23. The system of claim 22, wherein said order history comprises fifteen weeks of said forecasted demands.

24. The system of claim 1, wherein said order planning module further locates at least one other supplier of said plurality of suppliers when said at least one supplier cannot supply at least one item of said plurality of demanded items.

25. The system of claim 1, wherein said order planning module further receives customer preference information, said customer preference information representing at least one of parts and suppliers preferred by said plurality of customers, and supplier profile information, said supplier profile information representing suppliers to supply said parts.

26. The system of claim 1, wherein said order planning module further categorizes said plurality of customers into predefined groups and allocates available supply to said predefined groups according to predefined rules when demand for said plurality of demanded items is greater than supply for said demanded items.

27. The system of claim 1, wherein said order planning module further generates sales orders from said forecasted demands after accumulating a plurality of said forecasted demands from said at least one customer.

28. The system of claim 1, wherein said order management module further monitors purchase to pay cycle, communicates supply order data and reverse logistics, and monitors the movement of items.

29. The system of claim 28, wherein said order planning module further generates management information directed to said networked system, said management information including industry trends, commodity and product trends, forecast accuracy, and supplier performance.

30. The system of claim 29, wherein said logistics module further compares said forecasts with items located at a cross-dock.

31. The system of claim 1, wherein said order planning module further receives at least one of clean forecasts, past due sales orders, on hand inventories, safety stock requirements, and minimum and maximum usage.

32. The system of claim 31, wherein said past due sales orders appear as immediate demand to create supplier demand plan files.

33. The system of claim 29, wherein said logistics module further outputs said management information to reports.

34. A networked system for providing at least one customer of a plurality of customers with at least one demanded item from at least one supplier of a plurality of suppliers, said system performs supply base management, operations management, and infrastructure management.

35. The system of claim 34, wherein said networked system further aggregates forecasts received from said at least one customer, converts said aggregated forecasts of said at least one demanded item received from a customer from a first format to a second format.

36. The system of claim 35, wherein said converted aggregated forecasts comprise at least one supplier part number corresponding to at least one customer part number.

37. The system of claim 36, wherein said networked system further allocates available supply to fulfill said forecasts.

38. The system of claim 37, wherein said networked systems uses minimum package quantities while allocating said supply.

39. The system of claim 35, wherein said networked system further transmits said at least one converted forecast to said at least one supplier, receives at least one commitment directed to said at least one converted forecast from said at least one supplier, matches said at least one supplier providing said at least one commitment to said at least one customer, and allocates said committed supply to said at least one customer.

40. The system of claim 34, wherein said networked system further receives at least one ad hoc demand for items by said plurality of customers, converts said at least one ad hoc demand from a first format to a second format, transmits said at least one converted ad hoc demand to said supplier and, after said items are delivered to said customer, tracks payment for said item.

41. The system of claim 34, further comprising a frozen zone of time when orders cannot be altered.

42. The system of claim 41, wherein said system receives a demand for at least item during said frozen zone of time.

43. The system of claim 42, wherein said networked system locates a supplier able to provide said at least one demanded item to said customer during said frozen zone of time.

44. The system of claim 35, wherein said networked system further locates at least one alternate supplier of said plurality of suppliers when said at least one converted forecast exceeds said at least one commitment.

45. The system of claim 35, wherein said networked system receives information regarding constrained supply from at least one supplier, communicates with said at least one supplier to determine a cause for said constrained supply, and communicates with at least one customer to determine alternatives to said demanded item.

46. The system of claim 45, wherein said alternatives include alternate suppliers and alternate parts.

47. The system of claim 35, wherein said networked system further validates said at least one converted forecast and creates a customer sales order after said at least one converted forecast is validated.

48. The system of claim 47, wherein said step of validating further comprises determining whether each of said at least one converted forecast includes a quantity associated with each of at least one of said customer part number and said supplier part number.

49. The system of claim 48, wherein said step of validating further comprises determining whether each of at least one of said customer part number and said supplier part number included in said converted forecasts refers to a part, and whether said part is identified in a contractual agreement between said at least one customer and said at least one supplier.

50. The system of claim 47, wherein said networked system further receives information regarding available supply from said at least one supplier and determines whether said customer sales order can be fulfilled with said available supply.

51. The system of claim 50, wherein said networked system further generates a new customer sales order when said available supply cannot fulfill said customer sales order.

52. The system of claim 51, wherein said step of validating comprises at least one of determining whether said plurality of customers are authorized to issue said forecasts of demanded items, determining whether said at least one converted forecast is complete and determining whether each of said at least one converted forecast includes at least a ship-to location, a customer part number and a supplier part number.

53. The system of claim 34, wherein said networked system further groups sales orders by respective ship-to addresses.

54. The system of claim 34, wherein said networked system further uses at least one of a blanket purchase order and a discrete purchase to provide said at least customer with said at least one demanded item.

55. The system of claim 34, wherein said networked system further requires a purchase order from a customer regarding a specific item after determining a shortage.

56. The system of claim 54, wherein said network system requires an available to promise from said at least one supplier to provide said at least one customer with said at least one demanded item when at least one of said blank purchase order and said specific purchase order are unavailable.

57. The system of claim 34, wherein said networked system further generates a changed sales order when said at least one customer revises said forecasted demands.

58. The system of claim 57, wherein said forecasted demand is revised to include a changed ship-to locations.

59. A networked system of managed services, said networked system comprising:
operations management, said operations management adapted to perform at least one of receiving at least one demand forecast from said plurality of customers, monitoring markets and allocation, resolving issues and measuring supplier performance.

60. The system of claim 59, said operations management is further adapted to compare an aggregation of said at least one demand forecast with items located at a cross-dock.

61. The system of claim 59, wherein predefined rules are applied to allocating items during a frozen zone of time.

62. The system of claim 61, wherein said predefined rules include locating a supplier able to provide said at least one demanded item during said frozen zone of time.

63. The system of claim 54, wherein said operations management is further adapted to allocate available items among said plurality of customers when said available items represent an under-shipment.

64. The system of claim 59, wherein said operations management is further adapted to compare said aggregation of demand forecasts with available supply from said plurality of suppliers.

65. The system of claim 59, wherein said operations management is further adapted to generate at least one sales order from at least one of said at least one demand forecast and at least one ad hoc request.

66. The system of claim 65, wherein said operations management is further adapted to generate said at least one sales order by comparing said at least one demand forecast and said at least one ad hoc demand with a commitment received from said at least one supplier.

67. The system of claim 65, wherein said operations management further groups said sales orders by each of said at least one customer's ship-to address.

68. The system of claim 65, wherein each line in said at least one sales order represents a requested item.

69. The system of claim 65, wherein said at least one sales order comprises at least one of a customer purchase order identifier, a ship-to location, a bill-to location, a cross-dock location, a supplier part number, a customer part number, a preferred quantity, a price, a customer request date, a transportation service level, a promise date, and at least one special requirement.

70. The system of claim 65, wherein each of said at least one sales order includes a sales order line for said at least one demanded item when said at least one demanded item is available from at least two of said plurality of suppliers.

71. The system of claim 59, wherein said operations management is further adapted to identify part numbers and suggested suppliers for items demanded in ad hoc requests, convert said part numbers to supplier part numbers, modify a supply plan for a current week, transmit modified demand forecasts to said at least one supplier, and transmit pickup and delivery information directed to said ad hoc requests to third party logistics operators.

72. The system of claim 59, wherein said operations management is further adapted to generate consolidated purchase orders from said aggregated sales orders.

73. The system of claim 59, wherein said operations management is further adapted to provide sales order maintenance.

74. The system of claim 59, wherein said operations management is further adapted to transmit exception notifications to suppliers when a comparison of an advanced shipping notice and a supply plan reveals at least one of a over-shipment and an under-shipment.

75. The system of claim 74, wherein said operations management is further adapted to determine a disposition of excess material when said comparison reveals an over-shipment, and to engage in evaluations with said plurality of customers and said plurality of suppliers when said comparison reveals an under-shipment.

76. The system of claim 75, wherein said operations management is further adapted to execute a disposition plan when said comparison reveals an over-shipment, and to allocate supply when said comparison reveals an under-shipment.

77. The system of claim 75, wherein said operations management is further adapted to schedule a customer purchase order, to validate supply, and to create sales orders when no exceptions are revealed by said comparison.

78. The system of claim 59, wherein said operations management is further adapted to evaluate at least one of item quantity, delivery date, transportation, cross-dock location, direct shipment, packaging requirements, and special labeling.

79. The system of claim 78, wherein said operations management is further adapted to perform at least one of modifying said sales orders in response to a request by at least one of said at least one customer and said at least one supplier.

80. The system of claim 79, wherein said operations management is further adapted to change a delivery date and maintain said process of supplying said items when said at least one request includes a change to said delivery date.

81. The system of claim 79, wherein said operations management is further adapted to cancel said sales order and generates a new sale order when said at least one request includes a change to a bill-to address.

82. The system of claim 79, wherein said operations management is further adapted to verify a price change with said at least one customer and to validate said price change with said at least one supplier when said request includes a change to at least one of said demanded items.

83. The system of claim 59, wherein said at least one supplier notifies said operations management of a frozen zone of time when orders cannot be altered.

84. The system of claim 83, wherein said frozen window of time includes a predefined amount of time to complete at least one of a build to sales orders and an available to promise order.

85. The system of claim 83, wherein said operations management is further adapted to modify said sales orders to comply with requests for changes in at least one of demand forecast quantity and ship to date when said requests occur outside said frozen zone of time.

86. The system of claim 83, wherein said operations management receives an available to promise from said at least one supplier during said frozen window of time.

87. The system of claim 59, wherein said operations management is further adapted to change a purchase order number and to maintain said process of supplying said demanded items identified in said at least one demand forecast when said request includes a change to a purchase order.

88. The system of claim 59, wherein said operations management is further adapted to automatically generate an alert when said at least one demand forecast is greater than at least one of a plurality of sales orders during a predetermined time period.

89. The system of claim 59, wherein said operations management is further adapted to automatically generate at least one sales order when said at least one demand forecast is matched with said at least one supplier during a period of time when said sales orders cannot be modified.

90. The system of claim 89, wherein said operations management is further adapted to compare said sales orders with items included identified as an available to promise.

91. The system of claim 65, wherein said operations management is further adapted to identify at least one available supplier for items not identified in said at least one sales order.

92. The system of claim 59, wherein said operations management is further adapted to receive a customer preference profile, said customer preference profile including at least two preferred suppliers for items included in said demand forecast.

93. The system of claim 92, wherein said operations management is further adapted to locate suppliers other than suppliers identified in said customer preference profile and to provide said demanded items when at least one change to said demand forecast is received during a frozen zone of time.

94. The system of claim 92, wherein said operations management is further adapted to validate purchase orders received after at least one of said plurality of suppliers is matched to said uncommitted demand.

95. The system of claim 92, wherein said operations management is further adapted to use said customer preference profile to identify at least one available supplier of said demanded item.

96. The system of claim 92, wherein said operations management is further adapted to fill uncommitted demands with an available to promise for a current week with said at least one customer's first preferred supplier.

97. The system of claim 92, wherein said operations management is further adapted to fill uncommitted demands with an available to promise for a current week with said at least one customer's second preferred supplier when said at least one customer's first preferred supplier is unavailable.

98. The system of claim 92, wherein said operations management is further adapted to fill uncommitted demands with said available to promise for a current week with said at least one customer's second preferred supplier when said at least one customer's first preferred supplier is unavailable.

99. The system of claim 92, wherein said operations management is further adapted to fill said uncommitted demands in week subsequent to said current week when no one of said plurality of suppliers is able to fulfill said demand during a current week.

100. The system of claim 92, wherein said operations management is further adapted to locate at least one supplier other than suppliers identified in said customer preference profile to provide said demanded items when at least one change to said at least one demand forecast is received during a frozen zone of time.

101. The system of claim 92, wherein said operations management is further adapted to validate purchase orders received after at least one of said plurality of suppliers is matched to said uncommitted demand.

102. A networked system of managed services, said networked system comprising:
supply base management, said supply base management being adapted to perform at least one of negotiating with a plurality of suppliers on behalf of a plurality of customers, receiving price quotes from each of said plurality of suppliers, receiving labor source information, evaluating supplier performance, and providing customer support.

103. A networked system of managed services, said networked system comprising:
infrastructure management, said infrastructure management adapted to perform at least one of implementing and supporting data communications, interfaces, trade compliance and logistics, and delaying ordering of demanded items until an aggregation of a plurality of at least one forecast is received.

104. The system of claim 103, wherein said infrastructure management is further adapted to determine whether said items at said cross-dock represent at least one of an over-shipment and an under-shipment when said items at said cross-dock do not correspond with said accumulation of demand forecasts.

105. The system of claim 103, wherein said infrastructure management is further adapted to allocate orders, and to return orders that do not comply with said aggregation of demand forecasts.

106. The system of claim 103, wherein said infrastructure management is further adapted to manage receipt of sales orders, to aggregate said sales orders, to parse bulk shipments at a cross dock location, and to deliver subsets of said aggregated purchase orders to at least one customer.

107. The system of claim 103, wherein said infrastructure management is further adapted to transmit a supply plan to said at least one supplier, to receive an advance shipping notice from said at least one supplier, to generate a purchase order and to receive information for tracking contents of said sales order from said advanced shipping notice.

108. The system of claim 107, wherein said advance shipping notice includes cross-dock instructions transmitted to a third-party logistics provider.

109. The system of claim 107, wherein said advance shipping notice is used to generate at least one of a purchase order and a receipt notice indicating a position of said at least one of said plurality of demanded items.

110. The system of claim 109, wherein a receipt notice is created in an enterprise resource planning system.

111. A networked system of managed services, said networked system comprising error processing management, wherein said error processing management is adapted to generate an alert for at least one invalid condition.

112. The system of claim 111, wherein said at least one invalid condition includes at least one of an unplanned order, an item shortage, a past due order, an incomplete demand forecast, a missing ship-to location, a missing customer part number, a missing supplier part number and a missing quantity associated with at least one of a customer part number and a supplier part number.

113. The system of claim 111, wherein said error processing management is further adapted to notify said at least one customer and said at least one supplier of said alert.

114. A networked system of managed services, said networked system comprising financial management, wherein said financial management is adapted to receive a plurality of payments from at least one customer each day, and to consolidate said plurality of payments for each of a plurality of suppliers.

115. The system of claim 114, wherein said financial management is further adapted to execute purchasing processes.

116. The system of claim 115, wherein said purchasing processes are directed to a cycle of purchasing and paying.

117. The system of claim 113, wherein said financial management is further adapted to upload electronic financial payments to a financial institution and to each of said plurality of suppliers associated with said payments.

118. The system of claim 114, wherein said financing management is further adapted to update an enterprise resource planning system.

119. The system of claim 115, wherein said purchasing processes include sending at least one of said plurality of demanded items from said at least one supplier to said at least one customer, sending a financing payment for said item from a bank to a third party, forwarding said financing payment to said at least one supplier, sending a customer payment for said at least one of said plurality of items from said at least one customer to said bank.

120. A method for managing supply base operations for a plurality of suppliers and a plurality of customers, said method comprising:
receiving at least one forecast of a plurality of demanded items from at least one customer of said plurality of customers, and locating at least one supplier of said plurality of suppliers for said at least one forecast in said network;
controlling processes associated with distributing at least one item of said plurality of demanded items from said at least one supplier to said at least one customer;
monitoring reception of at least one item from said at least one supplier and monitors delivery of said at least one item to said at least one customer; and
providing for billing and payment of said at least one demanded item.

121. The method of claim 120, wherein said at least one forecast of said plurality of demanded items received by said order planning module from said at least one customer provides for thirteen weeks of future demands.

122. The method of claim 120, further comprising determining whether said at least one forecast complies with existing contractual obligations between said at least one customer and said at least one supplier.

123. The method of claim 122, further comprising generating an alert when said at least one forecast does not comply with said contractual obligations.

124. The method of claim 120, further comprising determining whether said at least one forecast contains errors.

125. The method of claim 124, wherein said errors include inaccurate part numbers.

126. The method of claim 120, further comprising receiving forecasted demands from said at least one customer for an item, converting said forecasted demands to represent supplier part numbers, delaying processing said demands until said order planning module collects customer information, said customer information including customer contract information and customer product information, and, after determining said demand is valid with said customer contract information and said customer product information, forwarding said forecasted demands to said plurality of suppliers.

127. The method of claim 126, further comprising receiving capacity exception information from said at least one supplier, said capacity exception information representing supply shortfalls in at least one week prior to a current week.

128. The method of claim 127, further comprising validating said forecasted demands in response to said capacity exception information.

129. The method of claim 120, further comprising receiving an ad hoc demand for an item from said at least one customer, converting said ad hoc demand to represent supplier part numbers, delaying processing said demand until said order planning module collects customer information, said customer information including customer contract information and customer product information, and after determining said demand is valid with said customer contract information and said customer product information with said demand, forwarding said ad hoc demand to said at least one supplier.

130. The method of claim 120, further comprising:
creating a supplier purchase order, said supplier purchase order based on an advanced shipping notice comprising a receipt and cross-dock instructions for third-party logistic operators;
delaying processing said supplier purchase order until requests for said demanded items are received and processed; and
generating a sales order and matching said receipt with said sales order and a supply plan received from said at least one supplier.

131. The method of claim 130, wherein said cross-dock instructions include at least one programming, assembly, aggregation, pickup, delivery instructions and customer return instructions.

132. The method of claim 120, further comprising performing reverse logistics, said reverse logistics including controlling processes to move said demanded items from a predetermined location to capture value and disposing of said demanded items.

133. The method of claim 120, further comprising:
receiving an advance shipping notice from said at least one supplier, said advance shipping notice representing at least one of an item shortage, cross dock instructions, a demanded item description;
cross referencing said advanced shipping notice with a previously received supply plan from said at least one supplier; and
creating a purchase order when said advanced shipping notice is cross-referenced.

134. The method of claim 120, wherein said at least one forecast is formatted as at least one of e-mail, XML, and EDI.

135. The method of claim 120, further comprising:
receiving information directed to contractual agreements between said plurality of customers and said plurality of suppliers;
receiving at least one request for at least one of items and services from said at least one customer; and
determining whether said at least one request is included in said contractual agreements.

136. The method of claim 135, wherein said services include at least one of expediting deliveries, providing special labeling, and providing special packaging.

137. The method of claim 120, further comprising:
receiving said forecasted demands from said customers and supply commitments from said suppliers;
validating at least one of said forecasted demands and said supply commitments; and
allocating available supply to fulfill said forecasted demands.

138. The method of claim 137, wherein said supply commitments represent items available from said supplier to fulfill said forecasted demands.

139. The method of claim 137, further comprising allocating available supply according to predefined rules when said supply commitment reveals said available supply cannot fulfill said forecasted demands.

140. The method of claim 139, wherein said available supply includes items that are previously identified as available to promise.

141. The method of claim 120, further comprising:
receiving said forecasted demands from said at east one customer;
receiving a supply commitment from said plurality of suppliers; and generating sales order commitments based upon said forecasted
demands and an order history of each of said at least one customer.

142. The method of claim 141, wherein said order history comprises fifteen weeks of said forecasted demands.

143. The method of claim 120, further comprising locating at least one other supplier of said plurality of suppliers when said at least one supplier cannot supply at least one item of said plurality of demanded items.

144. The method of claim 120, further comprising receiving customer preference information, said customer preference information representing at least one of parts and suppliers preferred by said plurality of customers, and supplier profile information, said supplier profile information representing suppliers to supply said parts.

145. The method of claim 120, further comprising categorizing said plurality of customers into predefined groups, and allocating available supply to said predefined groups according to predefined rules when demand for said plurality of demanded items is greater than supply for said demanded items.

146. The method of claim 120, further comprising generating sales orders from said forecasted demands after accumulating a plurality of said forecasted demands from said at least one customer.

147. The method of claim 120, further comprising monitoring purchase to pay cycle, communicating supply order data and reverse logistics, and monitoring the movement of items.

148. The method of claim 147, further comprising generating management information directed to said networked system, said management information including industry trends, commodity and product trends, forecast accuracy, and supplier performance.

149. The method of claim 148, further comprising comparing said forecasts with items located at a cross-dock.

150. The method of claim 120, further comprising receiving at least one of clean forecasts, past due sales orders, on hand inventories, safety stock requirements, and minimum and maximum usage.

151. The method of claim 150, wherein said past due sales orders appear as immediate demand to create supplier demand plan files.

152. The method of claim 147, further comprising outputting said management information to reports.

153. A method for providing at least one customer of a plurality of customers with at least one demanded item from at least one supplier of a plurality of suppliers, said method comprising performing supply base management, operations management, and infrastructure management.

154. The method of claim 153, further comprising aggregating forecasts received from said at least one customer, converting said aggregated forecasts of said at least one demanded item received from a customer from a first format to a second format.

155. The method of claim 154, wherein said converted aggregated forecasts comprise at least one supplier part number corresponding to at least one customer part number.

156. The method of claim 155, further comprising allocating available supply to fulfill said forecasts.

157. The method of claim 156, further comprising uses minimum package quantities when allocating said supply.

158. The method of claim 154, further comprising transmitting said at least one converted forecast to said at least one supplier, receiving at least one commitment directed to said at least one converted forecast from said at least one supplier, matching said at least one supplier providing said at least one commitment to said at least one customer, and allocating said committed supply to said at least one customer.

159. The method of claim 153, further comprising receiving at least one ad hoc demand for items by said plurality of customers, converting said at least one ad hoc demand from a first format to a second format, transmitting said at least one converted ad hoc demand to said supplier and, after said items are delivered to said customer, tracking payment for said item.

160. The method of claim 153, further comprising defining a frozen zone of time when orders cannot be altered.

161. The method of claim 160, further comprising receiving a demand for at least item during said frozen zone of time.

162. The method of claim 161, further comprising locating a supplier able to provide said at least one demanded item to said customer during said frozen zone of time.

163. The method of claim 154, further comprising locating at least one alternate supplier of said plurality of suppliers when said at least one converted forecast exceeds said at least one commitment.

164. The method of claim 154, further comprising receiving information regarding constrained supply from at least one supplier, communicating with said at least one supplier to determine a cause for said constrained supply, and communicating with at least one customer to determine alternatives to said demanded item.

165. The method of claim 164, wherein said alternatives include alternate suppliers and alternate parts.

166. The method of claim 154, further comprising validating said at least one converted forecast and creating a customer sales order after said at least one converted forecast is validated.

167. The method of claim 166, wherein said step of validating further comprises determining whether each of said at least one converted forecast includes a quantity associated with each of at least one of said customer part number and said supplier part number.

168. The method of claim 167, wherein said step of validating further comprises determining whether each of at least one of said customer part number and said supplier part number included in said converted forecasts refers to a part, and whether said part is identified in a contractual agreement between said at least one customer and said at least one supplier.

169. The method of claim 166, further comprising receiving information regarding available supply from said at least one supplier and determining whether said customer sales order can be fulfilled with said available supply.

170. The method of claim 169, further comprising generating a new customer sales order when said available supply cannot fulfill said customer sales order.

171. The method of claim 170, wherein said step of validating comprises at least one of determining whether said plurality of customers are authorized to issue said forecasts of demanded items, determining whether said at least one converted forecast is complete and determining whether each of said at least one converted forecast includes at least a ship-to location, a customer part number and a supplier part number.

172. The method of claim 153, further comprising grouping sales orders by respective ship-to addresses.

173. The method of claim 153, further comprising requiring a blanket purchase order to provide said at least customer with said at least one demanded item.

174. The method of claim 153, further comprising requiring a purchase order from a customer regarding a specific item after determining a shortage.

175. The method of claim 173, further comprising requiring an available to promise from said at least one supplier to provide said at least one customer with said at least one demanded item when at least one of said blank purchase order and said specific purchase order are unavailable.

176. The method of claim 153, further comprising generating a changed sales order when said at least one customer revises said forecasted demands.

177. The method of claim 176, further comprising revising said forecasted demand to include a changed ship-to locations.

178. A method for managing services, said method comprising:
performing at least one of receiving at least one demand forecast from said plurality of customers, monitoring markets and allocation, resolving issues and measuring supplier performance.

179. The method of claim 178, further comprising comparing an aggregation of said at least one demand forecast with items located at a cross-dock.

180. The method of claim 178, further comprising applying predefined rules to allocate items during a frozen zone of time.

181. The method of claim 180, wherein said predefined rules include locating a supplier able to provide said at least one demanded item during said frozen zone of time.

182. The method of claim 178, further comprising allocating available items among said plurality of customers when said available items represent an under-shipment.

183. The method of claim 178, further comprising comparing said aggregation of demand forecasts with available supply from said plurality of suppliers.

184. The method of claim 178, further comprising generating at least one sales order from at least one of said at least one demand forecast and at least one ad hoc request.

185. The method of claim 184, further comprising generating said at least one sales order by comparing said at least one demand forecast and said at least one ad hoc demand with a commitment received from said at least one supplier.

186. The method of claim 184, further comprising grouping said sales orders by each of said at least one customer's ship-to address.

187. The method of claim 184, wherein each line in said at least one sales order represents a requested item.

188. The method of claim 184, wherein said at least one sales order comprises at least one of a customer purchase order identifier, a ship-to location, a bill-to location, a cross-dock location, a supplier part number, a customer part number, a preferred quantity, a price, a customer request date, a transportation service level, a promise date, and at least one special requirement.

189. The method of claim 184, wherein each of said at least one sales order includes a sales order line for said at least one demanded item when said at least one demanded item is available from at least two of said plurality of suppliers.

190. The method of claim 178, further comprising identifying part numbers and suggested suppliers for items demanded in ad hoc requests, converting said part numbers to supplier part numbers, modifying a supply plan for a current week, transmitting modified demand forecasts to said at least one supplier, and transmitting pickup and delivery information directed to said ad hoc requests to third party logistics operators.

191. The method of claim 178, further comprising generating consolidated purchase orders from said aggregated sales orders.

192. The method of claim 178, further comprising providing sales order maintenance.

193. The method of claim 178, further comprising transmitting exception notifications to suppliers when a comparison of an advanced shipping notice and a supply plan reveals at least one of a over-shipment and an under-shipment.

194. The method of claim 193, further comprising determining a disposition of excess material when said comparison reveals an over-shipment, and engaging in evaluations with said plurality of customers and said plurality of suppliers when said comparison reveals an under-shipment.

195. The method of claim 194, further comprising executing a disposition plan when said comparison reveals an over-shipment, and allocating supply when said comparison reveals an under-shipment.

196. The method of claim 194, further comprising scheduling a customer purchase order, validating supply, and creating sales orders when no exceptions are revealed by said comparison.

197. The method of claim 178, further comprising evaluating at least one of item quantity, delivery date, transportation, cross-dock location, direct shipment, packaging requirements, and special labeling.

198. The method of claim 197, further comprising performing at least one of modifying said sales orders in response to a request by at least one of said at least one customer and said at least one supplier.

199. The method of claim 198, further comprising changing a delivery date and maintaining said process of supplying said items when said at least one request includes a change to said delivery date.

200. The method of claim 198, further comprising canceling said sales order and generating a new sale order when said at least one request includes a change to a bill-to address.

201. The method of claim 198, further comprising verifying a price change with said at least one customer and validating said price change with said at least one supplier when said request includes a change to at least one of said demanded items.

202. The method of claim 178, further comprising receiving a notification from said at least one supplier of a frozen zone of time when orders cannot be altered.

203. The method of claim 202, wherein said frozen window of time includes a predefined amount of time to complete at least one of a build to sales orders and an available to promise order.

204. The method of claim 202, further comprising modifying said sales orders to comply with requests for changes in at least one of demand forecast quantity and ship to date when said requests occur outside said frozen zone of time.

205. The method of claim 202, further comprising receiving an available to promise from said at least one supplier during said frozen window of time.

206. The method of claim 178, further comprising changing a purchase order number and maintaining said process of supplying said demanded items identified in said at least one demand forecast when said request includes a change to a purchase order.

207. The method of claim 178, further comprising automatically generating an alert when said at least one demand forecast is greater than at least one of a plurality of sales orders during a predetermined time period.

208. The method of claim 178, further comprising automatically generating at least one sales order when said at least one demand forecast is matched with said at least one supplier during a period of time when said sales orders cannot be modified.

209. The method of claim 208, further comprising comparing said sales orders with items included identified as an available to promise.

210. The method of claim 184, further comprising identifying at least one available supplier for items not identified in said at least one sales order.

211. The method of claim 178, further comprising receiving a customer preference profile, said customer preference profile including at least two preferred suppliers for items included in said demand forecast.

212. The method of claim 211, further comprising locating suppliers other than suppliers identified in said customer preference profile and providing said demanded items when at least one change to said demand forecast is received during a frozen zone of time.

213. The method of claim 211, further comprising validating purchase orders received after at least one of said plurality of suppliers is matched to said uncommitted demand.

214. The method of claim 211, further comprising using said customer preference profile to identify at least one available supplier of said demanded item.

215. The method of claim 211, further comprising filling uncommitted demands with an available to promise for a current week with said at least one customer's first preferred supplier.

216. The method of claim 211, further comprising filling uncommitted demands with an available to promise for a current week with said at least one customer's second preferred supplier when said at least one customer's first preferred supplier is unavailable.

217. The method of claim 211, further comprising filling uncommitted demands with said available to promise for a current week with said at least one customer's second preferred supplier when said at least one customer's first preferred supplier is unavailable.

218. The method of claim 211, further comprising filling said uncommitted demands in week subsequent to said current week when no one of said plurality of suppliers is able to fulfill said demand during a current week.

219. The method of claim 211, further comprising locating at least one supplier other than suppliers identified in said customer preference profile to provide said demanded items when at least one change to said at least one demand forecast is received during a frozen zone of time.

220. The method of claim 211, further comprising validating purchase orders received after at least one of said plurality of suppliers is matched to said uncommitted demand.

221. A method for managed services, said method comprising:
performing at least one of negotiating with a plurality of suppliers on behalf of a plurality of customers, receiving price quotes from each of said plurality of suppliers, receiving labor source information, evaluating supplier performance, and providing customer support.

222. A method of managed services, said method comprising performing at least one of implementing and supporting data communications, interfaces, trade compliance and logistics, and delaying ordering of said demanded items until an aggregation of a plurality of said at least one forecast is received.

223. The method of claim 222, further comprising determining whether said items at said cross-dock represent at least one of an over-shipment and an under-shipment when said items at said cross-dock do not correspond with said accumulation of demand forecasts.

224. The method of claim 222, further comprising allocating orders that comply with said aggregation of demand forecasts, and returning orders that do not comply with said aggregation of demand forecasts.

225. The method of claim 222, further comprising managing receipt of sales orders, aggregating said sales orders, parsing bulk shipments at a cross dock location, and delivering subsets of said aggregated purchase orders to at least one customer.

226. The method of claim 222, further comprising transmitting a supply plan to said at least one supplier, receiving an advance shipping notice from said at least one supplier, generating a purchase order and receiving information for tracking contents of said sales order from said advanced shipping notice.

227. The method of claim 226, wherein said advance shipping notice includes cross-dock instructions transmitted to a third-party logistics provider.

228. The method of claim 226, further comprising using said advance shipping notice to generate at least one of a purchase order and a receipt notice indicating a position of said at least one of said plurality of demanded items.

229. The method of claim 228, further comprising creating a receipt notice in an enterprise resource planning system.

230. A method of managed services, said method comprising processing errors, wherein said step of processing errors comprises generating an alert for at least one invalid condition.

231. The method of claim 230, wherein said at least one invalid condition includes at least one of an unplanned order, an item shortage, a past due order, an incomplete demand forecast, a missing ship-to location, a missing customer part number, a missing supplier part number and a missing quantity associated with at least one of a customer part number and a supplier part number.

232. The method of claim 230, wherein said step of processing errors further comprises notifying said at least one customer and said at least one supplier of said alert.

233. A method of managed services, said method comprising receiving a plurality of payments from said at least one customer each day, and consolidating said plurality of payments for each of said plurality of suppliers.

234. The method of claim 233, further comprising executing purchasing processes.

235. The method of claim 234, wherein said purchasing processes are directed to a cycle of purchasing and paying.

236. The method of claim 232, further comprising uploading electronic financial payments to a financial institution and to each of said plurality of suppliers associated with said payments.

237. The method of claim 233, further comprising updating an enterprise resource planning system.

238. The method of claim 234, wherein said purchasing processes include sending at least one of said plurality of demanded items from said at least one supplier to said at least one customer, sending a financing payment for said item from a bank to a third party, forwarding said financing payment to said at least one supplier, sending a customer payment for said at least one of said plurality of items from said at least one customer to said bank.
